(19) United States
(12) Patent Application Publication
(10) Pub. No.: US 2009/0110907 A1
(43) Pub. Date: Apr. 30, 2009

(54) Membranes Based On Poly (Vinyl Alcohol-Co-Vinylamine)

(76) Inventors: Dayue D. Jiang, Painted Post, NY (US); Wei Liu, Richland, WA (US); Paul John Shustack, Elmira, NY (US); Jianguo Wang, Horseheads, NY (US)

Correspondence Address: CORNING INCORPORATED, SP-TI-3-1, CORNING, NY, 14831, US

(21) Appl. No.: 12/112,535

(22) Filed: Apr. 30, 2008

Related U.S. Application Data
(60) Provisional application No. 61/000,816, filed on Oct. 29, 2007.

(51) Int. Cl. B32B 3/26; C08F 291/08; B05D 3/02; C08J 5/00

(52) U.S. Cl. 428/315.9; 526/310; 264/331.16; 427/373

(57) ABSTRACT

Polymer membranes that include a crosslinked poly(vinyl alcohol-co-vinylamine), which membranes are non-porous or are porous with pores having a median pore size of 300 nm or less. Also disclosed are polymer membranes which include a crosslinked poly(vinyl alcohol-co-vinylamine) and which also include a second polyamine wherein the poly(vinyl alcohol-co-vinylamine) and the second polyamine are crosslinked with one another.

### CROSS-REFERENCE TO RELATED APPLICATIONS

This application claims the benefit of priority to provisional application No. 61/000,816, titled “Membranes Based On Poly (Vinyl Alcohol-Co-Vinylamine)” filed on Oct. 29, 2007, attorney docket no. SP07-209P, the contents of which are incorporated by reference herein.

### FIELD OF THE INVENTION

The present invention relates, generally, to membranes and, more particularly, to membranes based on poly(vinyl alcohol-co-vinylamine) that can be used, for example, for molecular level separations and to methods for making the same.

### BACKGROUND OF THE INVENTION

There are a number of industrial processes, such as coal gasification, biomass gasification, steam reforming of hydrocarbons, partial oxidation of natural gas, etc., which produce gas streams that include CO₂, H₂ and CO. It is frequently desirable to remove CO₂ from those gas mixtures to capture CO₂, for example, for sequestration purposes and to produce H₂ or H₂-enriched gas product.

One process commonly used in the industry today to remove CO₂ from those gas mixtures involves the use of amine-based gas scrubbers. In these scrubbers, the gas mixture is contacted with an amine-containing organic solvent or an amine-containing solution. CO₂ and other acidic molecules, such as H₂S, are selectively absorbed in the amine solution. The process takes advantage of the strong interaction between the amine, a base, and the CO₂, an acid, leading to formation of a carbamate salt, as shown in FIG. 1.

However, the amine absorption technique has notable drawbacks and inefficiencies. For example, the amine absorption technique requires a large amount of aqueous amine solution. The technique also requires a pump and an amine/CO₂ regeneration system, because, once the amine solution is saturated, it needs to be reactivated. Reactivation involves the removal of the bound CO₂ from the amine groups in the solution, and this process uses large amounts of energy. Moreover, the amine absorption technique can corrode equipment, and the amine solution loses viability over a short period of time.

Polymer membrane technology makes the process simpler while still utilizing the chemistry between the amino group and the CO₂ molecule. Not only does the use of polymer membrane technology make such a complex system as mentioned above unnecessary, it also overcomes problems associated with the need for regeneration and the loss of viability of the amine solution.

In view of the foregoing, there is a need for polymer membranes that can be used for molecular level separations, and the present invention is directed, at least in part, to addressing this need.

### SUMMARY OF THE INVENTION

The present invention relates to a polymer membrane that includes crosslinked poly(vinyl alcohol-co-vinylamine), wherein the membrane is non-porous or wherein the membrane is porous with pores having a median pore size of 300 nm or less.

The present invention also relates to a polymer membrane that includes crosslinked poly(vinyl alcohol-co-vinylamine), wherein the polymer membrane further comprises a second polyamine and wherein the poly(vinyl alcohol-co-vinylamine) and the second polyamine are crosslinked with one another.

The present invention also relates to a method for preparing a polymer membrane that includes crosslinked poly(vinyl alcohol-co-vinylamine), wherein the membrane is non-porous or wherein the membrane is porous with pores having a median pore size of 300 nm or less. The method includes providing a membrane precursor composition comprising a poly(vinyl alcohol-co-vinylamine) and a crosslinking agent; casting the membrane precursor composition in the form of a film; and curing the film under conditions effective for the crosslinking agent to crosslink the poly(vinyl alcohol-co-vinylamine).

The present invention also relates to a method for preparing a polymer membrane that includes crosslinked poly(vinyl alcohol-co-vinylamine) and a second polyamine in which the poly(vinyl alcohol-co-vinylamine) and the second polyamine are crosslinked with one another. The method includes providing a membrane precursor composition comprising a poly(vinyl alcohol-co-vinylamine) and a crosslinking agent; casting the membrane precursor composition in the form of a film; and curing the film under conditions effective for the crosslinking agent to crosslink the poly(vinyl alcohol-co-vinylamine), wherein the membrane precursor composition further comprises a second polyamine and wherein the film is cured under conditions effective for the crosslinking agent to crosslink the poly(vinyl alcohol-co-vinylamine) and the second polyamine with one another.

The present invention also relates to a hybrid membrane structure that includes:

an inorganic porous support including a first end, a second end, and a plurality of inner channels having surfaces defined by porous walls and extending through the support from the first end to the second end;

optionally, one or more porous inorganic intermediate layers coating the inner channel surfaces of the inorganic porous support; and

a polymer membrane according to the present invention; wherein, when the hybrid membrane structure does not include the one or more porous inorganic intermediate layers, the inner channel surfaces of the inorganic porous support have a median pore size of 500 nanometers or less and the polymer membrane coats the inner channel surfaces of the inorganic porous support; and wherein, when the hybrid membrane structure includes the one or more porous inorganic intermediate layers, the polymer membrane coats the surface of the one or more porous intermediate layers.

The present invention also relates to a hybrid membrane structure that includes:

an inorganic porous support including a first end, a second end, and a plurality of inner channels having surfaces defined by porous walls and extending through the support from the first end to the second end;

optionally, one or more porous inorganic intermediate layers coating the inner channel surfaces of the inorganic porous support; and

a polymer membrane that includes crosslinked poly(vinyl alcohol-co-vinylamine), wherein the membrane is non-porous or wherein the membrane is porous with pores having a median pore size of 300 nm or less; wherein, when the hybrid membrane structure does not include the one or more porous inorganic intermediate layers, the polymer membrane coats the inner channel surfaces of the inorganic porous support and wherein, when the hybrid membrane structure includes the one or more porous inorganic intermediate layers, the polymer membrane coats the surface of the one or more porous intermediate layers.

The present invention also relates to a hybrid membrane structure that includes:

an inorganic porous support including a first end, a second end, and a plurality of inner channels having surfaces defined by porous walls and extending through the support from the first end to the second end;

optionally, one or more porous inorganic intermediate layers coating the inner channel surfaces of the inorganic porous support; and

a polymer membrane that includes crosslinked poly(vinyl alcohol-co-vinylamine), wherein the polymer membrane further includes a second polyamine and wherein the poly(vinyl alcohol-co-vinylamine) and the second polyamine are crosslinked with one another; wherein, when the hybrid membrane structure does not include the one or more porous inorganic intermediate layers, the polymer membrane coats the inner channel surfaces of the inorganic porous support and wherein, when the hybrid membrane structure includes the one or more porous inorganic intermediate layers, the polymer membrane coats the surface of the one or more porous intermediate layers.

The present invention also relates to a membrane precursor composition that includes a poly(vinyl alcohol-co-vinylamine); a second polyamine; and a crosslinking agent.

The present invention also relates to a method for making a hybrid membrane structure. The method includes:

providing an inorganic porous support including a first end, a second end, and a plurality of inner channels having surfaces defined by porous walls and extending through the support from the first end to the second end; optionally applying one or more porous inorganic intermediate layers to the inner channel surfaces of the inorganic porous support;

applying a membrane precursor composition that includes a poly(vinyl alcohol-co-vinylamine) and a crosslinking agent; wherein, when the one or more porous inorganic intermediate layers have not been applied to the inorganic porous support's inner channel surfaces, the inner channel surfaces of the inorganic porous support have a median pore size of 500 nanometers or less and the membrane precursor composition is applied to the inner channel surfaces of the inorganic porous support; and wherein, when the one or more porous inorganic intermediate layers have been applied to the inorganic porous support's inner channel surfaces, the membrane precursor composition is applied to the surface of the one or more porous intermediate layers; and

curing the membrane precursor composition under conditions effective for the crosslinking agent to crosslink the poly(vinyl alcohol-co-vinylamine).

The present invention also relates to a method for making a hybrid membrane structure. The method includes:

providing an inorganic porous support including a first end, a second end, and a plurality of inner channels having surfaces defined by porous walls and extending through the support from the first end to the second end;

optionally applying one or more porous inorganic intermediate layers to the inner channel surfaces of the inorganic porous support;

applying a membrane precursor composition that includes a poly(vinyl alcohol-co-vinylamine), a second polyamine, and a crosslinking agent; wherein, when the one or more porous inorganic intermediate layers have not been applied to the inorganic porous support's inner channel surfaces, the membrane precursor composition is applied to the inner channel surfaces of the inorganic porous support; and wherein, when the one or more porous inorganic intermediate layers have been applied to the inorganic porous support's inner channel surfaces, the membrane precursor composition is applied to the surface of the one or more porous intermediate layers; and

curing the membrane precursor composition under conditions effective for the crosslinking agent to crosslink the poly(vinyl alcohol-co-vinylamine) and the second polyamine with one another.

The present invention also relates to a membrane precursor composition that includes a poly(vinyl alcohol-co-vinylamine); a second polyamine; and a crosslinking agent.

The present invention also relates to a method for making a hybrid membrane structure. The method includes:

providing an inorganic porous support including a first end, a second end, and a plurality of inner channels having surfaces defined by porous walls and extending through the support from the first end to the second end;

optionally applying one or more porous inorganic intermediate layers to the inner channel surfaces of the inorganic porous support;

applying a membrane precursor composition that includes a poly(vinyl alcohol-co-vinylamine) and a crosslinking agent; wherein, when the one or more porous inorganic intermediate layers have not been applied to the inorganic porous support's inner channel surfaces, the membrane precursor composition is applied to the inner channel surfaces of the inorganic porous support; and wherein, when the one or more porous inorganic intermediate layers have been applied to the inorganic porous support's inner channel surfaces, the membrane precursor composition is applied to the surface of the one or more porous intermediate layers; and

curing the membrane precursor composition under conditions effective for the crosslinking agent to crosslink the poly(vinyl alcohol-co-vinylamine) into a membrane which is non-porous or which is porous with pores having a median pore size of 300 nm or less.

These and additional features and embodiments of the present invention will be more fully illustrated and discussed in the following drawings and detailed description.

### BRIEF DESCRIPTION OF THE DRAWINGS

FIG. 1 is a scheme showing the general interaction between CO₂ and amines.

FIGS. 2A and 2B are schematic representations of a hybrid membrane structure according to the present invention. FIG. 2A is a perspective view, and FIG. 2B is a longitudinal cross-sectional view of the hybrid membrane structure shown in FIG. 2A taken through FIG. 2A's Plane A.

FIG. 3 is a longitudinal cross-sectional schematic representation of a hybrid membrane structure according to the present invention.

FIG. 4A is a schematic representation of a hybrid membrane structure according to the present invention showing its use in a gas separation application. FIG. 4B is a scheme showing a possible mechanism for separating CO₂ from a feed gas using a polymer membrane according to the present invention.

FIG. 5 shows the chemical structures of various materials that can be used in the preparation of membranes, membrane precursor compositions, and hybrid membrane structures of the present invention.

FIG. 6 is a schematic perspective view of the polymer membrane-coated ceramic monoliths produced in Example 4 showing the cutting plane and imaging direction for the SEM images set forth in FIGS. 7A-7C and in FIGS. 8A-8D.

FIGS. 7A-7C are SEM images of a cross-section of the ceramic monolith coated with the PVAAm/PAAm/CARBODILITE™ V-02 membrane at magnifications of 40×, 400×, and 5000×, respectively.

FIGS. 8A-8D are SEM images of a cross-section of the ceramic monolith coated with the PVAAm/PAAm/formaldehyde membrane at magnifications of 100×, 500×, and 10000×, and 20000× respectively.

FIG. 9 is a schematic illustration of a vacuumed flow coating apparatus and process for casting a membrane precursor composition in accordance with the present invention on surfaces in a ceramic monolith's channels.

FIG. 10 is a plot of normalized infrared peak intensity of the carbodiimide band (2119 cm⁻¹) as a function of time at varying temperatures and shows the kinetics for the reaction between PVAAm and CARBODILITE™ V-02.

FIG. 11 is an FTIR spectrum of a PAAm/PVAAm based polymer membrane of the present invention, confirming the presence of amino groups in the membrane.

FIGS. 12A and 12B are reaction schemes showing the reactions of 1,2,3,4-butanetetracarboxylic acid with alcohol and amine functionalities, respectively.

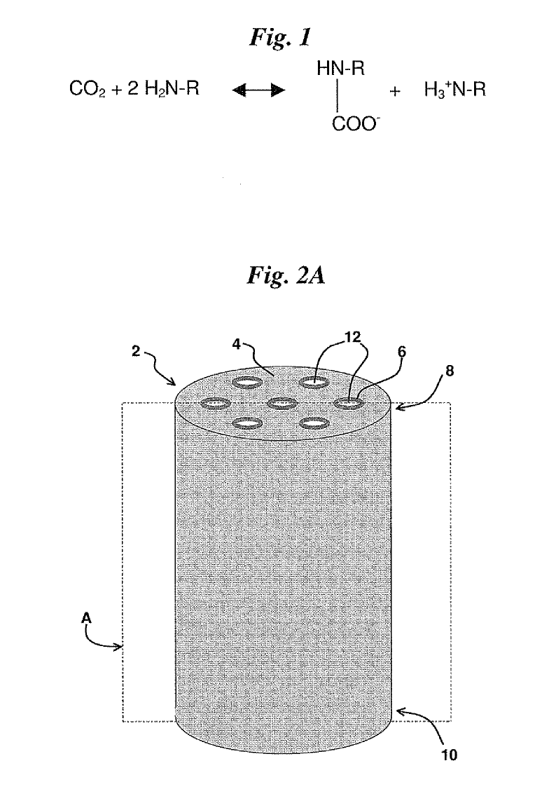

The embodiments set forth in the figures are illustrative in nature and not intended to be limiting of the invention defined by the claims. Individual features of the drawings and the invention will be more fully discussed in the following detailed description.

### DETAILED DESCRIPTION OF THE INVENTION

One aspect of the present invention relates to a polymer membrane that includes a crosslinked poly(vinyl alcohol-co-vinylamine).

Examples of suitable crosslinked poly(vinyl alcohol-co-vinylamine) that can be used in the polymer membranes of the present invention include those having the following formula:

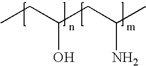

those which include from 1 mol % to 99 mol % vinylamine; those which include from 2 mol % to 90 mol % vinylamine; those which include from 5 mol % to 80 mol % vinylamine; those which include from 5 mol % to 75 mol % vinylamine; those which include from 5 mol % to 70 mol % vinylamine; those which include from 5 mol % to 60 mol % vinylamine; those which include from 5 mol % to 50 mol % vinylamine; those which include from 5 mol % to 40 mol % vinylamine; those which include from 5 mol % to 30 mol % vinylamine; those which include from 5 mol % to 20 mol % vinylamine; those which include from 5 mol % to 15 mol % vinylamine; those which include from 10 mol % to 50 mol % vinylamine; those which include from 10 mol % to 40 mol % vinylamine; those which include from 10 mol % to 30 mol % vinylamine; those which include from 10 mol % to 20 mol % vinylamine; those which include from 10 mol % to 15 mol % vinylamine; those which include 6 mol % vinylamine; those which include 12 mol % vinylamine; and/or those which include 13 mol % vinylamine. The poly(vinyl alcohol-co-vinylamine) can be a random copolymer, a sequential copolymer, a block copolymer, a graft copolymer, or a combination thereof.

In certain embodiments, the polymer membrane further includes a second polyamine, and the poly(vinyl alcohol-co-vinylamine) and the second polyamine are crosslinked with one another.

As used herein, “polyamine” is meant to refer to any polymer that includes a repeating amine, such as a repeating primary amine, a repeating secondary amine, a repeating tertiary amine, a repeating quaternary amine, or combinations thereof. The repeating amine can be bonded directly to the polymer backbone (e.g., as in the case of polyvinylamine); or it can be contained in a repeating functional group (e.g., as in the case of polyallylamine and as in the case of the primary amine in polyethylenimine); or it can be part of the backbone (e.g., as in the case of the secondary amine in polyethylenimine).

Since poly(vinyl alcohol-co-vinylamine) is a polyamine, “second polyamine” is meant to refer to any polyamine other than poly(vinyl alcohol-co-vinylamine).

Suitable “second polyamines” include, for example, polyallylamines, polyvinylamines, polyvinylpyridines (e.g., poly(2-vinylpyridine) and poly(4-vinylpyridine)), and polyaminoalkylmethacrylates (e.g., polyaminoethylmethacrylates and polydimethylaminoethylmethacrylates and other polydialkylaminoethylmethacrylates). Other suitable “second polyamines” include, for example, polyethylenimine, polyvinylimidazole, and polymers that include quaternary ammonium salts, such as polydiallyldimethylammonium chloride and those having the formula:

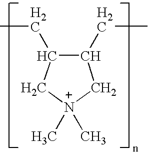

Still other suitable “second polyamines” include, for example, copolymers of different amino-functionalized monomers (random copolymers, sequential copolymers, block copolymers, graft copolymers, etc.), such as poly(dimethylaminoprolyl methacrylamide-co-hydroxyethyl methacrylate), poly(vinylpyrrolidone-co-dimethylaminoethylmethacrylate), and copolymers having the following formula:

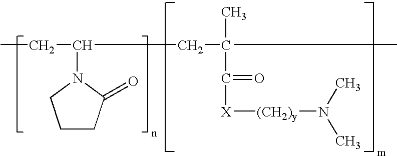

in which X can be, for example, O or NH and in which y can be, for example 2 or 3; and amino-dendrimers/star polymers and copolymers, such as those having the formula:

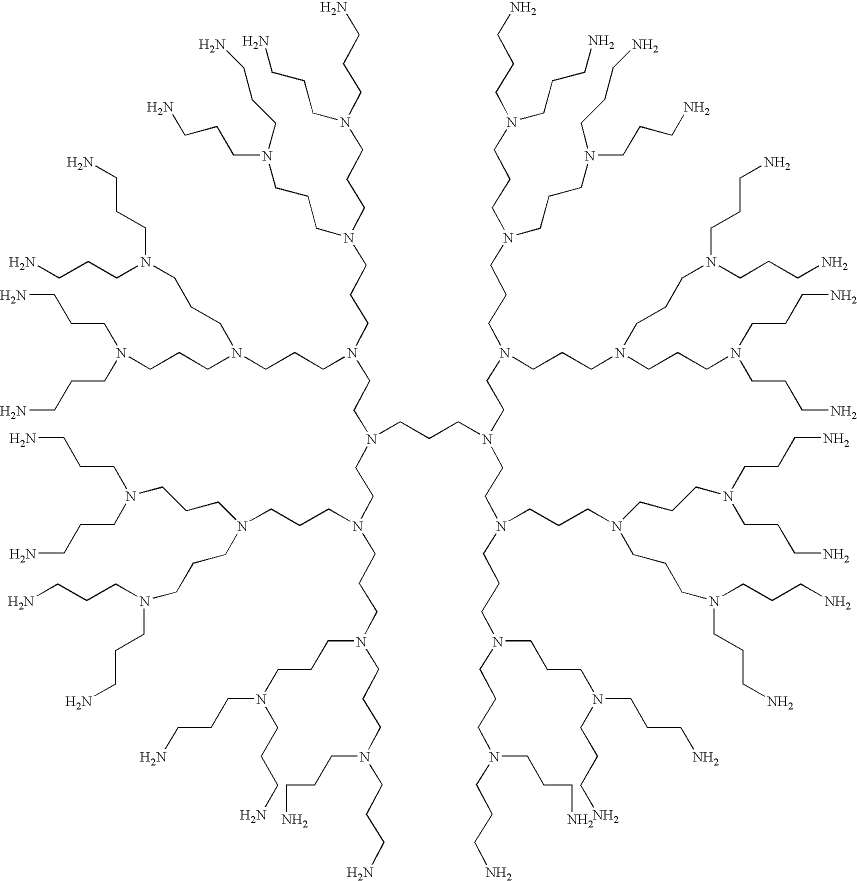

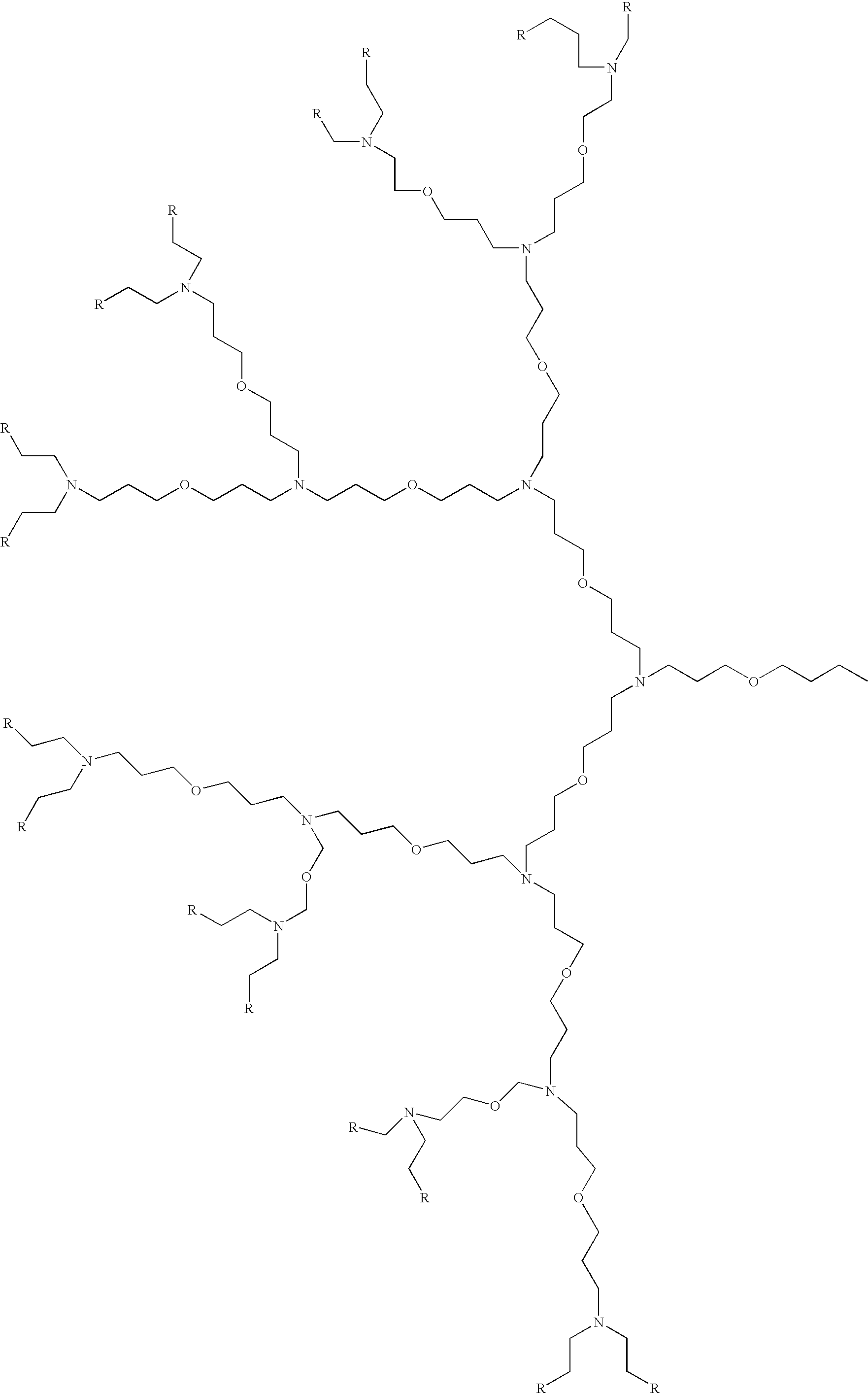

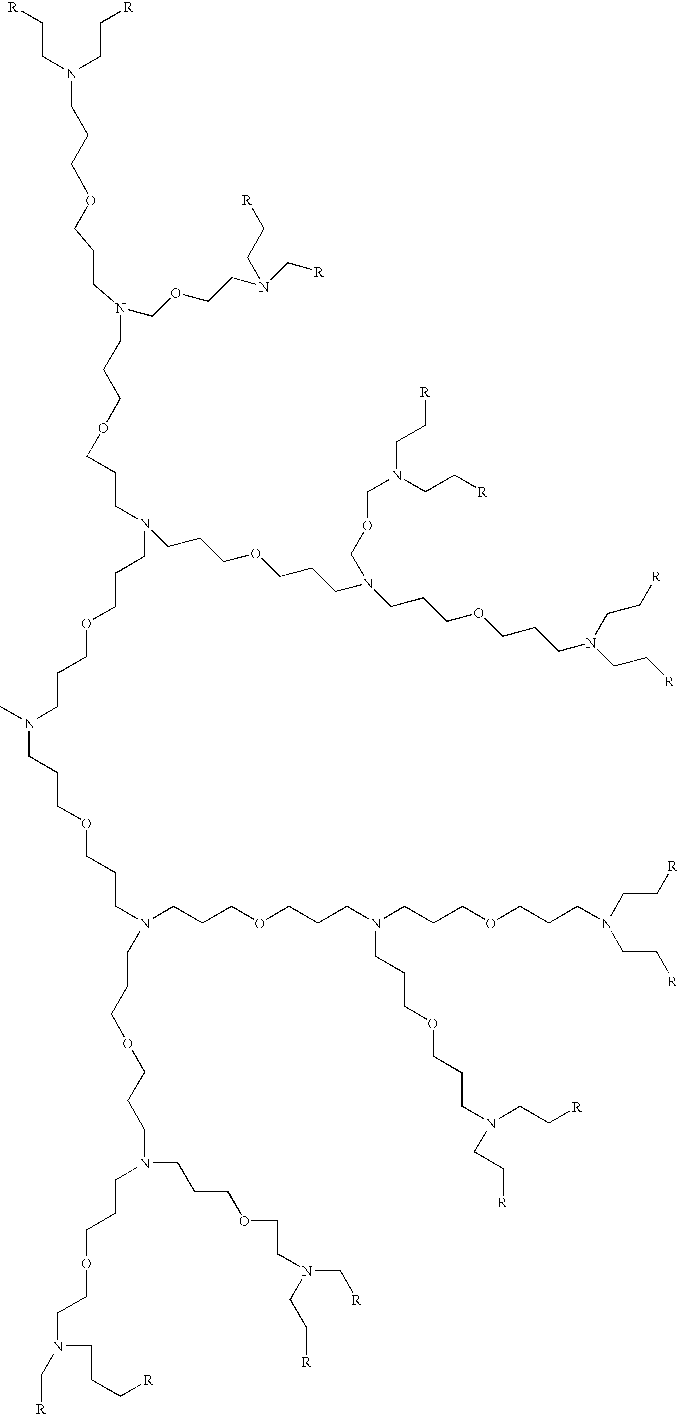

wherein R may represent, for example, H, alkyl, aryl, OH, etc.

Still other suitable “second polyamines” include, for example, polyaminoacids, in neat or salt (e.g., hydrochloride salt, hydrobromide salt, etc) form, such as poly-L-arginine, poly-D-lysine, poly-DL-onithine, poly-L-histidine, as well as copolymers (e.g., random copolymers, sequential copolymers, block copolymers, graft copolymers, etc.) thereof.

Still other suitable “second polyamines” include polymers containing N-heterocycles or hydrazines. Example second polyamines include Poly(acrylamide-co-diallyldimethylammonium chloride)

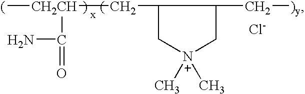

Poly[N,N′-bis(2,2,6,6-tetramethyl-4-piperidinyl)-1,6-hexanediamine-co-2,4-dichloro-6-morpholino-1,3,5-triazine]

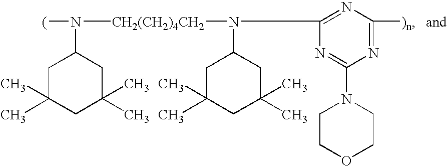

alkoxylated polyamine, e.g. polyethylenimine, ethoxylated

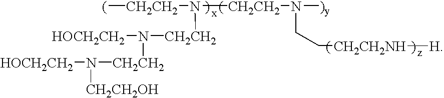

Combinations of these or other “second polyamines” can also be used.

Illustratively, in certain embodiments, the polymer membrane of the present invention further includes a polyallylamine, and the poly(vinyl alcohol-co-vinylamine) and the polyallylamine are crosslinked with one another.

The polymer membrane of the present invention can include other materials (i.e., in addition to the poly(vinyl alcohol-co-vinylamine) and the optional “second polyamines”).

By way of illustration, in certain embodiments, the polymer membrane further includes a mobile non-polymeric amine. As used herein, “mobile non-polymeric amine” is meant to refer to low molecular weight chemicals (e.g., molecular weights of under 500 g/mol, such as under 400 g/mol, under 300 g/mol, under 200 g/mol, under 100 g/mol, etc.) that contain one or more amine functional groups. The amine functional groups can be primary amine functional groups, secondary amine functional groups, or tertiary amine functional groups, and the mobile non-polymeric amine can contain combinations of these kinds of amine functional groups. For example, in certain embodiments, the non-polymeric amine is a non-polymeric tertiary amine (i.e., in which the amine functional group is a tertiary amine or, in cases where the non-polymeric amine contains more than one amine functional group, in which all of the amine functional groups are tertiary amines). Illustratively, suitable mobile non-polymeric amines include glycine, glycine salts (e.g., glycine sodium salt, glycine potassium salt, etc.), hexyldiamine, and N,N-dimethylethyldiamine. Other suitable mobile non-polymeric amines include amino acids (in neat form or in a salt form), such as alanine, glycine, dimethylglycine, arginine, histidine, lysine, etc. Combinations of these or other mobile non-polymeric amines can also be used.

It is believed that the mobile non-polymeric amines can act as a mobile phase of absorbents within the polymer membrane, which can be particularly useful when the polymer membrane is used in certain applications (e.g., for separating CO₂ from a feed gas).

The poly(vinyl alcohol-co-vinylamine) (and, when included in the polymer membrane, the optional “second polyamine”) can be crosslinked with any suitable crosslinking agent. Suitable crosslinking agents include thermo-crosslinking agents (e.g., those activated by the application of heat), photo-crosslinking agents (e.g., those activated by the application of radiation, such as UV radiation or other forms of electromagnetic radiation), and crosslinking agents that are activated either by heat or by radiation or by both. Examples of suitable crosslinking agents include Michael addition products. Further examples of suitable crosslinking agents include aldehydes, epoxies, imidates, isocyanates, melamine formaldehyde, epichlorohydrin, 2,5-dimethoxytetrahydrofuran, and 2-(4-dimethylcarbamyl-pyridino)ethane-1-sulfonate. Further examples of suitable crosslinking agents include those having the following formulae:

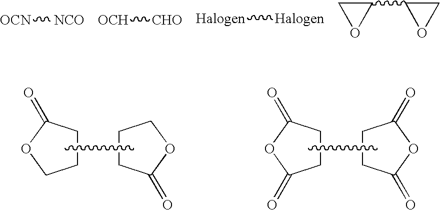

(where the wavy line represents a direct or indirect bond or series of bonds connecting (e.g., covalently), the two moieties shown (e.g., the two isocyanate moieties, the two aldehyde moieties, etc.)), examples of which include glutaraldehyde, malonaldehyde, glyoxal, p-phthalaldehyde, glycerol diglycidyl ether, glycerol propoxylate triglycidyl ether, neopentyl glycol diglycidyl ether, and 1,4-butandediol diglycidyl ether. Still further examples of suitable crosslinking agents include macromolecular crosslinking agents, such as polymeric or oligomeric compounds containing a plurality of reactive moieties selected from, for example, aldehyde, epoxy, imidate, isocyanate, and combinations thereof. By way of illustration, suitable macromolecular crosslinking agents include poly(N-vinylformamide), oxidized starch, acetoacetylated polyvinyl alcohol, diacetone acrylamide copolymerized polyvinyl alcohol, copoly(vinyl acetate)-(N-vinyl-pyrrolidone), poly(methyl vinyl ether-alt-maleic anhydride), and poly(isobutene-alt-maleic anhydride) and its partial salts (e.g., its partial ammonium salt). Still further examples of suitable crosslinking agents include inorganic crosslinking agents, such as ammonium zirconium carbonate crosslinking agents (e.g., BACOTE™ 20); crosslinking agents containing blocked aldehyde functional groups, such as aldehydes of the type tetrahydro-4-hydroxy-5-methyl-2(1H)-pyrimidinone polymers (e.g., SUNREZ™ 700; and crosslinking agents based on polyamide-epichlorohydrin-type resins (e.g., POLYCUP™ 172).

Illustratively, in certain embodiments, the poly(vinyl alcohol-co-vinylamine) is crosslinked with an aldehyde; in certain embodiments, the poly(vinyl alcohol-co-vinylamine) is crosslinked with formaldehyde; in certain embodiments, the poly(vinyl alcohol-co-vinylamine) is crosslinked with a polycarbodiimide crosslinking agent; in certain embodiments, the poly(vinyl alcohol-co-vinylamine) is crosslinked with a polyacid crosslinking agent. Combinations of these and other crosslinking agents can be used as well.

As used herein, “polycarbodiimide crosslinking agent” is meant to refer to crosslinking agents that include two or more carbodiimide groups (—N═C═N—) in each molecule. Some polycarbodiimide crosslinking agents are commercially available as oligomers or polymers having generally two or more carbodiimide groups. In certain embodiments, each of the carbodiimide groups (—N═C═N—) are bonded to an aralkyl moiety, e.g., as in the case where the crosslinking agents include two or more groups having the formula: —Ar—R—N═C═N—R—Ar—, where Ar represents an aryl group (e.g., an unsubstituted phenyl group or a substituted phenyl group (such as in the case where the phenyl group bears a methyl or other alkyl substituent or an aryl substituent) and R represents an alkyl group (e.g., a substituted or unsubstituted methyl, such as in the case where —R— represents a —C(CH₃)₂— group, etc.) In certain embodiments, the polycarbodiimide crosslinking agent contains repeating units having the following structure: N═C═N—R—Ar—R′, where —Ar— represents a substituted or unsubstituted phenyl group or other aryl group and where R and R′ independently represent an alkyl group (e.g., a substituted or unsubstituted methyl, such as in the case where each of —R— and —R′— represents a —C(CH₃)₂— group, etc.) . Examples of suitable polycarbodiimide crosslinking agents include CARBODILITE™ E-01, CARBODILITE™ E-02, CARBODILITE™ V-02, CARBODILITE™ V-02-L2, CARBODILITE™ V-04, CARBODILITE™ V-06, produced by Nisshinbo Industries, Inc., Tokyo, Japan). In certain embodiments, the poly(vinyl alcohol-co-vinylamine) is crosslinked with a polycarbodiimide crosslinking agent having the following formula:

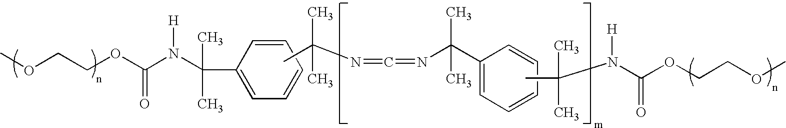

As used herein, “polyacid crosslinking agent” is meant to refer to crosslinking agents that include three or more acid groups (e.g., three carboxylic acid groups, four carboxylic acid groups, five carboxylic acid groups, etc.) in each molecule. Examples of suitable polyacid crosslinking agents include 1,2,3,4-butanetetracarboxylic acid (“BTCA”), citric acid, and ethylenediamine tetraacetic acid (“EDTA”). Other examples of suitable polyacid crosslinking agents include oligomers and polymers which contain three or more acid groups, such as polyacrylic acids and terpolymers of maleic acid.

The poly(vinyl alcohol-co-vinylamine) (and, when included in the polymer membrane, the optional “second polyamine,” for example a poly vinyl alcohol-containing polymer) can be crosslinked through thermal treatment(thermal crosslinking), with or without the addition of a crosslinking agent. An example heat treatment is heating at a temperature of 150° C. or above for several minutes.

In certain embodiments, the polymer membrane has a thickness of from 1 micron to 60 microns. In certain embodiments, the polymer membrane has a thickness of from 1 micron to 30 microns. Other examples of suitable thicknesses for the polymer membrane include 2±1 microns, 5±2 microns, 10±5 microns, 20±5 microns, 30±5 microns, 40±5 microns, 50±5 microns, and/or from 55 microns to 60 microns.

In other embodiments, the polymer membrane has a thickness of less than 1 micron, for example a thickness of 500 nm or less, 400 nm or less, 300 nm or less, 200 nm or less, or 100 nm or less.

In certain embodiments, the thickness of the polymer membrane is substantially uniform, such as in the case where the thickness of the polymer membrane deviates from the polymer membrane's average thickness by less than 50% (e.g., by less than 40%, by less than 30%, by less than 20%) over 90% or more (e.g., over 95% or more, over 98% or more, etc.) of the membrane's area. In certain embodiments, the polymer membrane is substantially uniformly thick and has a thickness of from 1 micron to 60 microns.

In certain embodiments, the polymer membrane is non-porous. In certain embodiments, the polymer membrane includes pores having a median pore size of 300 nm or less, such as in cases where the polymer membrane includes pores having a median pore size of 250 nm or less, of 200 nm or less, of 150 nm or less, of 100 nm or less, of 75 nm or less, of 50 nm or less, of 40 nm or less, of 30 nm or less, of 20 nm or less, of 10 nm or less, of 5 nm or less, of 4 nm or less, of 3 nm or less, of 2 nm or less, of 1 nm or less, of 0.5 nm or less, of 0.4 nm or less, of 0.3 nm or less, of 0.2 nm or less, of 0.1 nm or less.

The polymer membranes of the present invention can be prepared by any suitable method. One suitable method, to which the present invention also relates, is set forth below.

The present invention also relates to a method for preparing a polymer membrane that includes crosslinked poly(vinyl alcohol-co-vinylamine). The method includes providing a membrane precursor composition comprising a poly(vinyl alcohol-co-vinylamine) and a crosslinking agent; casting the membrane precursor composition in the form of a film; and curing the film under conditions effective for the crosslinking agent to crosslink the poly(vinyl alcohol-co-vinylamine).

As noted above, the membrane precursor composition includes a poly(vinyl alcohol-co-vinylamine). Examples of suitable poly(vinyl alcohol-co-vinylamine)s include those discussed above. In certain embodiments, the poly(vinyl alcohol-co-vinylamine) is one that includes from 5 mol % to 80 mol % vinylamine. In certain embodiments poly(vinyl alcohol-co-vinylamine) is one that includes from 5 mol % to 20 mol % vinylamine. In certain embodiments poly(vinyl alcohol-co-vinylamine) is one that includes 12 mol % vinylamine.

In certain embodiments, the polymer membrane produced by the subject method is non-porous. In certain embodiments, the polymer membrane the polymer membrane produced by the subject method includes pores having a median pore size of 300 nm or less, such as in cases where the polymer membrane includes pores having a median pore size of 250 nm or less, of 200 nm or less, of 150 nm or less, of 100 nm or less, of 75 nm or less, of 50 nm or less, of 40 nm or less, of 30 nm or less, of 20 nm or less, of 10 nm or less, of 5 nm or less, of 4 nm or less, of 3 nm or less, of 2 nm or less, of 1 nm or less, of 0.5 nm or less, of 0.4 nm or less, of 0.3 nm or less, of 0.2 nm or less, of 0.1 nm or less.

In certain embodiments, the membrane precursor composition further includes a second polyamine. In cases where the membrane precursor composition further includes a second polyamine, the film is cured under conditions effective for the crosslinking agent to crosslink the poly(vinyl alcohol-co-vinylamine) and the second polyamine with one another. In certain embodiments, the membrane precursor composition further includes a second polyamine, and the second polyamine is selected from the group consisting of polyallylamines, polyvinylamines, polyvinylpyridines, polydimethylaminoethylmethacrylates, and combinations thereof. For example, in certain embodiments, the membrane precursor composition further includes a polyallylamine, and the film is cured under conditions effective for the crosslinking agent to crosslink the poly(vinyl alcohol-co-vinylamine) and the polyallylamine with one another. The second polyamine can be in neat base form, or it can be in the form of a salt. As indicated above, more than one second polyamine can be used (e.g., as in the case where the membrane precursor composition includes polyallylamine and polyvinylamine), and “second polyamine” is meant to encompass such combinations.

As noted above, the membrane precursor composition also includes a crosslinking agent. Examples of suitable crosslinking agents include those discussed above. In certain embodiments, the crosslinking agent is an aldehyde, such as formaldehyde. In certain embodiments, the crosslinking agent is a polycarbodiimide crosslinking agent, such as one having the following formula:

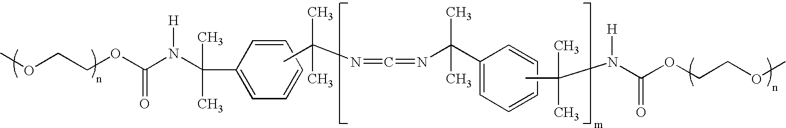

In certain embodiments, the crosslinking agent is a polyacid crosslinking agent, such as BTCA.

The amount of crosslinking agent employed can depend on the reactivity of the groups to be crosslinked, the crosslinking conditions to be employed, the crosslinking agent employed, and the desired properties of the crosslinked membrane. Suitable amounts of crosslinking agent include, for example, from 0.05 part to 1 part of crosslinking agent per part of poly(vinyl alcohol-co-vinylamine) by weight. The amount of crosslinking agent can also be selected based on a reactive group basis. Illustratively, the amount of crosslinking agent employed can be selected such that the number of crosslinking agent reactive groups present in the membrane precursor composition (e.g., in the case of glutaraldehyde, the number of aldehyde groups in the membrane precursor composition) is from 0.1 to 10 times (e.g., from 0.2 to 10 times, from 0.2 to 5 times, from 0.2 to 2 times, from 0.2 to 1 times, from 0.3 to 10 times, from 0.3 to 5 times, from 0.3 to 2 times, from 0.3 to 1 times, from 0.4 to 10 times, from 0.4 to 5 times, from 0.4 to 2 times, from 0.4 to 1 times, from 0.5 to 10 times, from 0.5 to 5 times, from 0.5 to 2 times, from 0.5 to 1 times) the number of polymeric amine groups (e.g., from the poly(vinyl alcohol-co-vinylamine) and “second polyamine”, if any) present in the membrane precursor composition.

Illustratively, the membrane precursor composition can be prepared by the following method. The poly(vinyl alcohol-co-vinylamine) and optional “second polyamine(s)” can be separately dissolved in suitable solvents (e.g., water, deionized water, alcohol, etc.) with optional heating and stirring, as needed. Although the same solvent is typically used, different solvents can be employed if necessary to promote dissolution. Where different solvents are employed, it may be advantageous for the various solvents to be miscible with one another. The solution(s) can be optionally filtered prior to use. In those cases where one or more “second polyamine” solutions have been prepared, the one or more “second polyamine” solutions are combined with the poly(vinyl alcohol-co-vinylamine) solution and mixed (e.g., with stirring). The crosslinker can then be added to the poly(vinyl alcohol-co-vinylamine) solution or to the poly(vinyl alcohol-co-vinylamine)/“second polyamine(s)” mixture, either neat or in the form of a solution (e.g., an aqueous solution), to form the membrane precursor composition.

Alternatively to the embodiments discussed above, the precursor composition need not contain a crosslinking agent when the poly(vinyl alcohol-co-vinylamine) (and/or, when included in the polymer membrane, the optional “second polyamine,” for example a poly vinyl alcohol-containing polymer) can be crosslinked through thermal treatment(thermal crosslinking).

The membrane precursor composition is then cast in the form of a film. A variety of methods can be used to cast the film, for example, dipping, spraying, painting, spin-coating, flowing, molding, etc. A doctor blade or a bird-type applicator can be used. The film can be cast onto an organic, inorganic, or other substrate. Examples of suitable substrates include inorganic porous supports, such as ceramic monoliths (discussed in greater detail below). Examples of other suitable substrates include glass substrates, polyester substrates, polyvinylchloride substrates, carbon substrates, polyvinylidine chloride substrates, acrylic substrates, polystyrene substrates, polyolefin substrates, nylon substrates, polyimide substrates, etc. The substrates can be flexible or rigid; and they can be in any suitable shape (e.g., substantially planar discs, films, sheets, etc. or other substantially planar shapes, hollow tubular shapes, ellipsoidal shapes, spherical shapes, cylindrical shapes, etc.). The film can be of any suitable thickness, such as from 1 micron to 100 microns, from 2 microns to 80 microns, from 5 microns to 60 microns, from 10 microns to 50 microns, etc. In certain embodiments, the substrate is a porous substrate, for example, as in the case where the porous substrate has a median pore size of 1 micron or less and/or as in the case where the porous substrate has a median pore size of 500 nanometers or less, such as in cases where the porous substrate has a median pore size of from 5 nanometers to 500 nanometers, from 5 nanometers to 400 nanometers, from 5 nanometers to 300 nanometers, from 5 nanometers to 400 nanometers, from 5 nanometers to 300 nanometers, from 5 nanometers to 400 nanometers, from 5 nanometers to 200 nanometers, from 5 nanometers to 100 nanometers, from 5 nanometers to 50 nanometers, etc.

The cast film can be dried, for example overnight at room temperature prior to curing.

The film is then cured under conditions effective to crosslink the poly(vinyl alcohol-co-vinylamine) (and the optional “second polyamine(s)”, in those cases where “second polyamine(s)” are being employed). Such conditions depend on a variety of factors, such as the thickness of the film, the type and amount of crosslinker being employed, the amine content of the poly(vinyl alcohol-co-vinylamine), the nature and amine content of any “second polyamine(s)” that might be present, the degree to which the film has been dried, etc. Illustratively, heating the film at from 50° C. to 220° C. (e.g., from 70° C. to 180° C., from 90° C. to 160° C., from 100° C. to 150° C., from 170° C. to 210° C., from 180° C. to 210° C., from 190° C. to 200° C., etc.) for from 2 minutes to 12 hours (e.g., for from 3 minutes to 12 hours, for from 5 minutes to 12 hours, for from 5 minutes to 10 hours, for from 5 minutes to 8 hours, for from 3 minutes to 10 minutes, for 5 minutes, for from 5 minutes to 4 hours, for from 1 hour to 8 hours, for from 2 hours to 8 hours, for from 3 hours to 6 hours, for 4 hours, etc.) is typically effective for the crosslinking agent to crosslink the poly(vinyl alcohol-co-vinylamine), thereby curing the film and producing the polymer membrane.

As discussed above, in certain embodiments, the polymer membrane includes a mobile non-polymeric amine. Polymer membranes that include a mobile non-polymeric amine can be produced in a variety of ways.

For example, the non-polymeric amine can be incorporated into the membrane precursor composition prior to casting the film. In those cases where the membrane precursor composition includes a polycarbodiimide crosslinking agent (e.g., CARBODILITE™ V-02) or a polyacid crosslinking agent (e.g., BTCA), it may be desirable to use a tertiary non-polymeric amine, so as to avoid interaction between the non-polymeric amine and the polycarbodiimide or polyacid crosslinking agent (which could reduce or otherwise adversely affect the non-polymeric amine's mobility).

Additionally or alternatively, the non-polymeric amine can be incorporated into the film after casting but before curing. This can be carried out, for example, by contacting the film, prior to curing, with the non-polymeric amine. The film is contacted with the non-polymeric amine under conditions effective for the non-polymeric amine to disperse in the film. Illustratively, depending on the nature of the non-polymeric amine and whether contact is carried out before or after drying, contacting can be carried out neat in the form of a liquid; in the form of a vapor; or in the form of a solution, dispersion, or suspension. For example, the non-polymeric amine or solution, dispersion, or suspension containing the non-polymeric amine can be contacted with the film by dipping, spraying, painting, spin-coating, flowing, and the like. In those cases where a polycarbodiimide crosslinking agent (e.g., CARBODILITE™ V-02) or a polyacid crosslinking agent (e.g., BTCA) is employed, it may be desirable to use a tertiary non-polymeric amine, so as to avoid interaction between the non-polymeric amine and the polycarbodiimide or polyacid crosslinking agent during the curing process (which, as noted above, could adversely affect the non-polymeric amine's mobility).

Still additionally or alternatively, the non-polymeric amine can be incorporated into the film after curing. This can be carried out, for example, by contacting the film, after curing, with the non-polymeric amine under conditions effective for the non-polymeric amine to disperse in the cured film. Illustratively, depending on the nature of the non-polymeric amine and the swelling characteristics of the cured film, contacting can be carried out neat in the form of a liquid; in the form of a vapor; or in the form of a solution, dispersion, or suspension. The crosslinked film will typically swell in water and other suitable solvents, which property can be readily exploited to effect dispersal of the non-polymeric amine into the cured film. For example, the non-polymeric amine or solution, dispersion, or suspension containing the non-polymeric amine can be contacted with the film by dipping, spraying, painting, spin-coating, flowing, and the like. The non-polymeric amine can be a tertiary non-polymeric amine, or it can be a non-polymeric amine that contains primary and/or secondary amine functional groups.

The present invention also relates to membrane precursor compositions, as described above, and the membrane precursor compositions of the present invention can be prepared, for example, in accordance with the methods set forth above.

The polymer membranes of the present invention and the polymer membranes prepared in accordance with the methods of the present invention can be used in a variety of molecular separation processes, such as in processes for separating CO₂ and/or H₂S from a feed gas, in pervaporation processes, or in liquid separation processes (such as nano-filtration processes or in liquid-liquid separations based on molecular size, shape, etc.). By way of illustration, polymer membranes that are non-porous or that include pores having a median pore size of 1 nanometer or less (e.g., having a median pore size of 0.3 nanometers or less) can be used in pervaporation and gas separation processes; while polymer membranes that include pores having a median pore size of from 2 nanometers to 300 nanometers can be used in liquid separation processes.

The present invention also relates to a hybrid membrane structure that includes:

an inorganic porous support including a first end, a second end, and a plurality of inner channels having surfaces defined by porous walls and extending through the support from the first end to the second end;

optionally, one or more porous inorganic intermediate layers coating the inner channel surfaces of the inorganic porous support; and

a polymer membrane according to the present invention; wherein, when the hybrid membrane structure does not include the one or more porous inorganic intermediate layers, the polymer membrane coats the inner channel surfaces of the inorganic porous support and wherein, when the hybrid membrane structure includes the one or more porous inorganic intermediate layers, the polymer membrane coats the surface of the one or more porous intermediate layers.

Suitable inorganic porous support materials include ceramics, glass ceramics, glasses, metals, clays, and combinations thereof. Examples of these and other materials from which the inorganic porous support can be made or which can be included in the inorganic porous support are, illustratively: metal oxide, alumina (e.g., alpha-aluminas, delta-aluminas, gamma-aluminas, or combinations thereof), cordierite, mullite, aluminum titanate, titania, zeolite, metal (e.g., stainless steel), ceria, magnesia, talc, zirconia, zircon, zirconates, zirconia-spinel, spinel, silicates, borides, alumino-silicates, porcelain, lithium alumino-silicates, feldspar, magnesium alumino-silicates, fused silica, carbides, nitrides, silicon carbides, silicon nitrides, and the like.

In certain embodiments, the inorganic porous support is primarily made from or otherwise includes alumina (e.g., alpha-alumina, delta-alumina, gamma-alumina, or combinations thereof), cordierite, mullite, aluminum titanate, titania, zirconia, zeolite, metal (e.g., stainless steel), silica carbide, ceria, or combinations thereof.

In one embodiment, the inorganic porous support is a glass. In another embodiment, the inorganic porous support is a glass-ceramic. In another embodiment, the inorganic porous support is a ceramic. In another embodiment, the inorganic porous support is a metal. In yet another embodiment, the inorganic porous support is carbon, for example a carbon support derived by carbonizing a resin, for example, by carbonizing a cured resin.

In certain embodiments, the inorganic porous support is in the form of a honeycomb monolith. Honeycomb monoliths can be manufactured, for example, by extruding a mixed batch material through a die to form a green body, and sintering the green body with the application of heat utilizing methods known in the art.

In certain embodiments, the inorganic porous support is in the form of a monolith, for instance a ceramic monolith. In certain embodiments, the monolith, for example a ceramic monolith, comprises a plurality of parallel inner channels.

The inorganic porous support can have a high surface area packing density, such as a surface area packing density of greater than 500 m²/m³, greater than 750 m²/m³, and/or greater than 1000 m²/m³.

As noted above, the inorganic porous support includes a plurality of inner channels having surfaces defined by porous walls.

The number, spacing, and arrangement of the inner channels is not particularly critical. For example the number of channels can range from 2 to 1000 or more, such as from 5 to 500, from 5 to 50, from 5 to 40, from 5 to 30, from 10 to 50, from 10 to 40, from 10 to 30, etc; and these channels can be of substantially the same cross sectional shape (e.g., circular, oval, etc.) or not. The channels can be substantially uniformly dispersed in the inorganic porous support's cross section or not (e.g., as in the case where the channels are arranged such that they are closer to the outer edge of the inorganic porous support than to the center. The channels can be arranged in a pattern (e.g., rows and columns, offset rows and columns, in concentric circles about the inorganic porous support's center, etc.

In certain embodiments, the inner channels of the inorganic porous support have a hydraulic inside diameter of from 0.5 millimeters to 3 millimeters, such as in cases where the inner channels of the inorganic porous support have a hydraulic inside diameter of 1±0.5 millimeter, 2±0.5 millimeter, from 2.5 millimeters to 3 millimeters, and/or from 0.8 millimeters to 1.5 millimeters. In certain embodiments, the inner channels of the inorganic porous support have a hydraulic inside diameter of less than 2 millimeters. For clarity, note that “diameter” as used in this context is meant to refer to the inner channel's cross sectional dimension and, in the case where the inner channel's cross section is non-circular, is meant to refer to the diameter of a hypothetical circle having the same cross sectional area as that of the non-circular inner channel.

In certain embodiments, the porous walls which define the inner channels' surfaces have a median pore size of 25 microns or less. In certain embodiments, the porous walls which define the inner channels' surfaces have a median pore size of from 5 nanometers to 25 microns, such as in cases where the porous walls which define the inner channels' surfaces have a median pore size of 10±5 nanometers, 20±5 nanometers, 30±5 nanometers, 40±5 nanometers, 50±5 nanometers, 60±5 nanometers, 70±5 nanometers, 80±5 nanometers, 90±5 nanometers, 100±5 nanometers, 100±50 nanometers, 200±50 nanometers, 300±50 nanometers, 400±50 nanometers, 500±50 nanometers, 600±50 nanometers, 700±50 nanometers, 800±50 nanometers, 900±50 nanometers, 1000±50 nanometers, 1±0.5 microns, and/or 2±0.5 microns. In certain embodiments, the porous walls which define the inner channels' surfaces have a median pore size of 1 micron or less. In certain embodiments, the porous walls which define the inner channels' surfaces have a median pore size of 500 nanometers or less, such as in cases where the porous walls which define the inner channels' surfaces have a median pore size of from 5 nanometers to 500 nanometers, from 5 nanometers to 400 nanometers, from 5 nanometers to 300 nanometers, from 5 nanometers to 400 nanometers, from 5 nanometers to 300 nanometers, from 5 nanometers to 400 nanometers, from 5 nanometers to 200 nanometers, from 5 nanometers to 100 nanometers, from 5 nanometers to 50 nanometers, etc. For clarity, note that “size” as used in this context is meant to refer to a pore's cross sectional diameter and, in the case where the pore's cross section is non-circular, is meant to refer to the diameter of a hypothetical circle having the same cross sectional area as that of the non-circular pore.

In certain embodiments, the inorganic porous support has a porosity of from 20 percent to 80 percent, such as a porosity of from 30 percent to 60 percent, from 50 percent to 60 percent, and/or from 35 percent to 50 percent. When a metal, such as stainless steel, is used as the inorganic porous support, porosity in the stainless steel support can be effected, for example, using engineered pores or channels made by three-dimensional printing, by high energy particle tunneling, and/or by particle sintering using a pore former to adjust the porosity and pore size.

It will be appreciated that individual inorganic porous supports can be stacked or housed in various manners to form larger inorganic porous supports having various sizes, service durations, and the like to meet the needs of differing use conditions.

As noted above, the hybrid membrane structure can optionally include one or more porous inorganic intermediate layers coating the inner channel surfaces of the inorganic porous support.

In certain embodiments, the hybrid membrane structure does not include the one or more porous inorganic intermediate layers, and the polymer membrane coats the inner channel surfaces of the inorganic porous support. In certain embodiments, the hybrid membrane structure does not comprise the one or more porous inorganic intermediate layers, the porous walls which define the inner channels' surfaces have a median pore size of 1 micron or less, and the polymer membrane coats the inner channel surfaces of the inorganic porous support. In certain embodiments, the hybrid membrane structure does not comprise the one or more porous inorganic intermediate layers, the porous walls which define the inner channels' surfaces have a median pore size of 500 nanometers or less (such as in cases where the porous walls which define the inner channels' surfaces have a median pore size of from 5 nanometers to 500 nanometers, from 5 nanometers to 400 nanometers, from 5 nanometers to 300 nanometers, from 5 nanometers to 400 nanometers, from 5 nanometers to 300 nanometers, from 5 nanometers to 400 nanometers, from 5 nanometers to 200 nanometers, from 5 nanometers to 100 nanometers, from 5 nanometers to 50 nanometers, etc.), and the polymer membrane coats the inner channel surfaces of the inorganic porous support.

In other embodiments, the hybrid membrane structure does include the one or more porous inorganic intermediate layers, and the polymer membrane coats the surface of the one or more porous intermediate layers.

In those cases where the hybrid membrane structure does include the one or more porous inorganic intermediate layers, and the polymer membrane coats the surface of the one or more porous intermediate layers, it will be appreciated that the “surface of the one or more porous intermediate layers” refers to the outer surface of the intermediate layer (i.e., the surface that is exposed to the channel) or, in the case where there is more than one porous intermediate layer, to the outer surface of the outermost intermediate layer (i.e., the intermediate layer most distant from the inner channel surfaces of the inorganic porous support). In particular, the phrase “the polymer membrane coats the surface of the one or more porous intermediate layers” is not meant to be construed as requiring that the polymer membrane coat every porous intermediate layer or every side of every porous intermediate layer.

Whether or not to employ the one or more porous inorganic intermediate layers can depend on a variety of factors, such as the nature of the inorganic porous support; the median diameter of the inorganic porous support's inner channels; the use to which the hybrid membrane structure is to be put and the conditions (e.g., gas flow rates, gas pressures, etc.) under which it will be employed; the roughness or smoothness of the inner channels' surfaces; the median pore size of the porous walls which define the inner channels' surfaces; and the like.

By way of illustration, in certain embodiments, the porous walls of the inorganic porous support comprise a median pore size that is sufficiently small so that, when the polymer membrane is coated directly on the inner channels' surfaces, the resulting coating is smooth. Examples of median pore sizes that are thought to be sufficiently small so as not to significantly benefit (in terms of smoothness of the polymer membrane) from the use of the porous inorganic intermediate layer(s) (for at least some applications) are those that are less than about 100 nanometers. Even less benefit is attained when the median pore size is less than about 80 nanometers; still less benefit is attained when the median pore size is less than about 50 nanometers (e.g., in the 5 nanometer to 50 nanometer range).

By way of further illustration, in certain embodiments, the porous walls of the inorganic porous support comprise a median pore size that is sufficiently large so that, when the polymer membrane is coated directly on the inner channels' surfaces, the resulting coating may be rough. In such cases, it may be advantageous to use the porous inorganic intermediate layer(s). Examples of median pore sizes that are thought to be sufficiently large so as to significantly benefit (in terms of smoothness of the polymer membrane coating) from the use of the porous inorganic intermediate layer(s) (for at least some applications) are those that are more than about 100 nanometers. Even greater benefit is attained when the median pore size is more than about 200 nanometers; still greater benefit is attained when the median pore size is more than about 300 nanometers (e.g., in the 300 nanometer to 50 micron range).

Illustratively, in certain embodiments, the porous walls of the inorganic porous support have a median pore size of from 5 nanometers to 100 nanometers (e.g., from 5 nanometers to 50 nanometers), the hybrid membrane structure does not include the one or more porous inorganic intermediate layers, and the polymer membrane coats the inner channel surfaces of the inorganic porous support. In other embodiments, the porous walls of the inorganic porous support have a median pore size of from 50 nanometers to 25 microns (e.g., from 100 nanometers to 15 microns), the hybrid membrane structure includes the one or more porous inorganic intermediate layers, and the polymer membrane coats the surface of the one or more porous intermediate layers.

As noted above, the one or more porous inorganic intermediate layers can be used to increase the smoothness of surface onto which the polymer membrane is coated (e.g., to improve flow of a gas that may pass through the channels; to improve uniformity of the polymer membrane coating; to decrease the number and/or size of any gaps, pinholes, or other breaks in the polymer membrane coating; to decrease the thickness of the polymer membrane coating needed to achieve a polymer membrane coating having an acceptably complete coverage (e.g. no or an acceptably small number of gaps, pinholes, or other breaks). Additionally or alternatively, the one or more porous inorganic intermediate layers can be used to decrease the effective diameter of the inorganic porous support's inner channels. Still additionally or alternatively, the one or more porous inorganic intermediate layers can be used to alter the chemical, physical, or other properties of the surface onto which the polymer membrane is coated.

Examples of materials from which the one or more porous inorganic intermediate layers can be made include metal oxides, ceramics, glasses, glass ceramics, carbon, and combinations thereof. Other examples of materials from which the one or more porous inorganic intermediate layers can be made include cordierite, mullite, aluminum titanate, zeolite, silica carbide, and ceria. In certain embodiments, the one or more porous inorganic intermediate layers are made from or otherwise include alumina (e.g., alpha-alumina, delta-alumina, gamma-alumina, or combinations thereof), titania, zirconia, silica, or combinations thereof.

In certain embodiments, the median pore size of each of the one or more porous inorganic intermediate layers is larger than the median pore size of the inorganic porous support's porous walls. By way of illustration, the one or more porous intermediate layers can comprise a median pore size of from 5 nanometers to 100 nanometers, such as from 5 nanometers to 50 nanometers, from 5 nanometers to 40 nanometers, from 5 nanometers to 30 nanometers, 10±5 nanometers, 20±5 nanometers, 30±5 nanometers, 40±5 nanometers, 50±5 nanometers, 60±5 nanometers, 70±5 nanometers, 80±5 nanometers, and/or 90±5 nanometers. Where two or more porous intermediate layers are present, each of the two or more porous intermediate layers can have the same median pore size or some or all of them can have different median pore sizes.

In certain embodiments, the hybrid membrane structure includes two or more porous intermediate layers, the median pore size of the porous intermediate layer which contacts the inorganic porous support is greater than the median pore size of the porous intermediate layer which contacts the polymer membrane. Illustratively, in cases where the inorganic porous support has a median pore size larger than 300 nm (e.g., larger than 500 nm, larger than 1 micron, larger than 2 microns, larger than 3 microns, etc.) the hybrid membrane structure can include two porous intermediate layers: the first layer (i.e., the one that is in contact with the inorganic porous support) having a median pore size that is smaller than the inorganic porous support's median pore size (e.g., having a median pore size of from 100 nm to 200 nm) and the second layer (i.e., the one that is in contact with the polymer membrane) having a median pore size that is smaller than the first layer's median pore size (e.g., having a median pore size of from 5 nm to 50 nm). Such arrangements can be used to provide a smooth surface onto which the polymer membrane is coated without unacceptably decreasing permeability from the inner channels, through the pores of the first intermediate layer, through the larger pores of the second intermediate layer, through the still larger pores of the inorganic porous support, and to the outside of the inorganic porous support.

In those cases where the hybrid membrane structure includes the one or more porous intermediate layers, the one or more porous intermediate layers can have a combined thickness of from 1 micron to 100 microns, such as from 2 microns to 80 microns, from 5 microns to 60 microns, 10 microns to 50 microns, etc.

As noted above, irrespective of whether or not the hybrid membrane structure includes the one or more porous intermediate layers, the hybrid membrane structure also includes a polymer membrane of the present invention. In those cases where the hybrid membrane structure does not include the one or more porous inorganic intermediate layers, the polymer membrane coats the inner channel surfaces of the inorganic porous support. In those cases where the hybrid membrane structure does include the one or more porous inorganic intermediate layers, the polymer membrane coats the surface of the one or more porous intermediate layers.

It will be appreciated that not all the channels need be coated with the polymer membrane. For example, the polymer membrane can coat all of the inner channel surfaces of the inorganic porous support; or the polymer membrane can coat some of the inner channel surfaces of the inorganic porous support; and the phrase “the polymer membrane coats the inner channel surfaces of the inorganic porous support” is meant to encompass both situations. Likewise, in those cases where the porous intermediate layer(s) is employed, the polymer membrane can coat the surface of the one or more porous intermediate layers in every channel; or the polymer membrane can coat the surface of the one or more porous intermediate layers in some of the channels; and the phrase “the polymer membrane coats the surface of the one or more porous intermediate layers” is meant to encompass both situations. Illustratively, depending on the expected conditions of use and the configuration of the channels in the inorganic porous support, it may be desirable to plug certain channels in the inorganic porous support, and these channels need not be coated with the polymer membrane; or it may be desirable not to plug certain channels in the inorganic porous support and not to coat these channels with the polymer membrane; or both.

Examples of suitable polymer membranes for use in the hybrid membrane structures of the present invention include those described hereinabove. In certain embodiments, the polymer membrane has a thickness of from 1 micron to 60 microns. In certain embodiments, the polymer membrane has a thickness of from 1 micron to 30 microns. Other examples of suitable thicknesses for the polymer membrane include 2±1 microns, 5±2 microns, 10±5 microns, 20±5 microns, 30±5 microns, 40±5 microns, 50±5 microns, and/or from 55 microns to 60 microns.

In other embodiments, the polymer membrane has a thickness of less than 1 micron, for example a thickness of 500 nm or less, 400 nm or less, 300 nm or less, 200 nm or less, or 100 nm or less.

In certain embodiments, the thickness of the polymer membrane is substantially uniform. In certain embodiments, the polymer membrane is substantially uniformly thick and has a thickness of from 1 micron to 60 microns. In certain embodiments, the polymer membrane is substantially uniformly thick and has a thickness of less than 1 micron.

In certain embodiments, the polymer membrane is non-pourous. In certain embodiments, the polymer membrane includes pores having a median pore size of 300 nm or less, such as in cases where the polymer membrane includes pores having a median pore size of 250 nm or less, of 200 nm or less, of 150 nm or less, of 100 nm or less, of 75 nm or less, of 50 nm or less, of 40 nm or less, of 30 nm or less, of 20 nm or less, of 10 nm or less, of 5 nm or less, of 4 nm or less, of 3 nm or less, of 2 nm or less, of 1 nm or less, of 0.5 nm or less, of 0.4 nm or less, of 0.3 nm or less, of 0.2 nm or less, of 0.1 nm or less.

In certain embodiments, the hybrid membrane structure does not comprise the one or more porous inorganic intermediate layers, and the polymer membrane is non-porous. In certain embodiments, the hybrid membrane structure does not comprise the one or more porous inorganic intermediate layers, and the polymer membrane includes pores having a median pore size of 300 nm or less, such as in cases where the polymer membrane includes pores having a median pore size of 250 nm or less, of 200 nm or less, of 150 nm or less, of 100 nm or less, of 75 nm or less, of 50 nm or less, of 40 nm or less, of 30 nm or less, of 20 nm or less, of 10 nm or less, of 5 nm or less, of 4 nm or less, of 3 nm or less, of 2 nm or less, of 1 nm or less, of 0.5 nm or less, of 0.4 nm or less, of 0.3 nm or less, of 0.2 nm or less, of 0.1 nm or less.

In those cases in which the polymer membrane includes pores, the median pore size of the polymer membrane can be smaller than the median pore size of the surface onto which it is coated (e.g., of the inner channel surface of the inorganic porous support or, when the hybrid membrane structure includes the one or more porous inorganic intermediate layers, of the surface of the one or more porous intermediate layers).

In certain embodiments, the polymer membrane further includes (i.e., in addition to the poly(vinyl alcohol-co-vinylamine)) a second polyamine, and the poly(vinyl alcohol-co-vinylamine) and the second polyamine are crosslinked with one another.

For certain applications, it may be desirable that the polymer membrane coats the entire surface of the porous intermediate layer(s) or the entire inner channel surfaces of the inorganic porous support, for example such that none or substantially none (e.g., less than 20%, less than 10%, less than 5%, less than 1%, less than 0.1%, less than 0.01%, etc.) of a gaseous component of a feed gas (e.g., H₂, CO, etc.) in the inner channels permeates to the outside of the inorganic porous support. As further illustration, for certain applications, it may be desirable that the number and/or size of any gaps, pinholes, or other breaks in the polymer membrane coating be small in size and few in number (e.g., as in the case where there are no gaps, pinholes, or other breaks in the polymer membrane coating or as in the case where the collective area of any gaps, pinholes, or other breaks in the polymer membrane coating is less than 1% (such as less than 0.1%, 0.01%, etc.) of the total surface area coated by the polymer membrane coating.

Certain embodiments of the present invention can have advantages over prior art polymer membranes and prior art inorganic membranes, for example, in terms of durability and/or strength; in terms of regeneration or refurbishment; and/or in terms of permeation flux (for structures to be used in gas separation applications).

By way of illustration, in certain embodiments of the hybrid membrane structures of the present invention, the inorganic porous support structure can provide a backbone for surface area, mechanical strength, and durability; and use of the inorganic porous support can also overcome the thermal and chemical stability issues associated with some pure polymeric membranes while providing surface area packing density comparable to the pure polymeric membranes.

Additionally or alternatively, in certain embodiments of the hybrid membrane structures of the present invention, the inorganic porous support structure can facilitate regeneration or refurbishment of the hybrid membrane structures. Illustratively, the inorganic porous support can be a major cost factor in the production of the hybrid membrane structures, while the preparation of the polymeric membrane coating itself can be significantly less costly. The inorganic porous support structure can offer thermal stability at high temperatures (e.g., at calcination temperature >900° C.) at which all the organic materials can be burnt out. This feature can permit the inorganic porous support structure (with or without the one or more inorganic intermediate layers) to be reused. For example, when the hybrid membrane structure is degraded, the polymer membrane layer (and any other polymeric layers that may be present) can be burnt out, and the inorganic porous support structure (and the optional one or more porous inorganic intermediate layers that coat the inner channel surfaces of the inorganic porous support) can be readily refurbished with a new polymer membrane layer (and, if desired, with other polymeric layer(s)).

Still additionally or alternatively, in certain embodiments of the hybrid membrane structures of the present invention, the inorganic porous support can have a substantially uniform pore structure on the inorganic porous support channel surfaces (or substantially uniform pore structure can be generated by the use of the optional one or more porous inorganic intermediate layers). This can enable deposition of a thin and durable polymer membrane layer (e.g., by a simple coating process with solution chemistry); and the thin polymeric amine-containing membrane layer can offer high permeation flux. The hybrid membrane structures can thus provide a large potential advantage in manufacturing cost relative to the cost of manufacturing prior art inorganic membranes.

It will be appreciated that all, some, or none of the advantages discussed above may or may not be achieved in a particular hybrid membrane structure of the present invention. For example, a particular hybrid membrane structure of the present invention may be designed with other considerations in mind, and these other considerations may reduce or negate some or all of the above-discussed advantages or other advantages. The advantages discussed above are not meant to be limiting; and they are not to be construed, in any way, as limiting the scope of the invention.

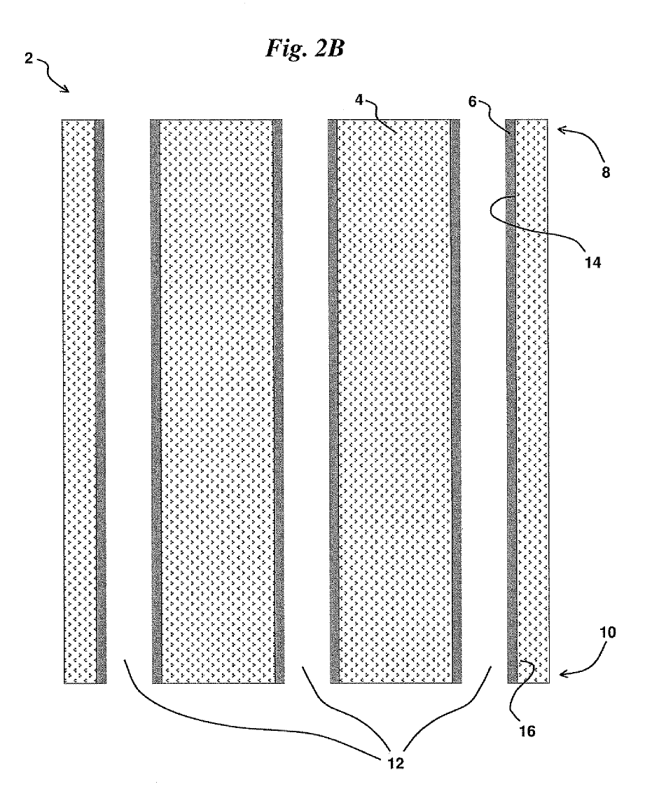

Referring to FIGS. 2A and 2B, an exemplary hybrid membrane structure 2 is illustrated. FIG. 2A is a perspective view, and FIG. 2B is a longitudinal cross-sectional view of the hybrid membrane structure shown in FIG. 2A taken through FIG. 2A's Plane A. In this embodiment, hybrid membrane structure 2 includes inorganic porous support 4 and polymer membrane 6, and no porous inorganic intermediate layers are employed in this embodiment. Inorganic porous support 4 is shown as including first end 8, second end 10, and plurality of inner channels 12 that extend through inorganic porous support 4 from first end 8 to second end 10. Inner channels 12 have surfaces 14 defined by porous walls 16, and polymer membrane 6 coats surfaces 14 of inner channels 12.

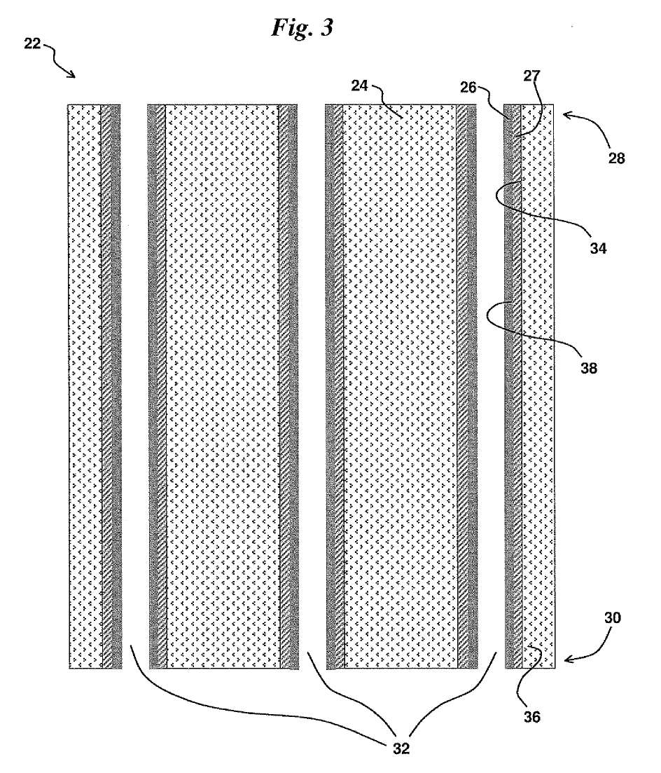

Another exemplary hybrid membrane structure 22 is illustrated in FIG. 3. In this embodiment, hybrid membrane structure 22 includes inorganic porous support 24, polymer membrane 26, and porous inorganic intermediate layer 27. Inorganic porous support 24 is shown as including first end 28, second end 30, and plurality of inner channels 32 that extend through inorganic porous support 24 from first end 28 to second end 30. Inner channels 32 have surfaces 34 defined by porous walls 36, and porous inorganic intermediate layer 27 coats surfaces 34 of inner channels 32. Polymer membrane 26 coats porous inorganic intermediate layer 27's surface 38.

The hybrid membrane structures of the present invention can be prepared by a variety of methods, such as, for example, by the methods discussed below.

The present invention also relates to a method for making a hybrid membrane structure. The method includes:

providing an inorganic porous support including a first end, a second end, and a plurality of inner channels having surfaces defined by porous walls and extending through the support from the first end to the second end;

optionally applying one or more porous inorganic intermediate layers to the inner channel surfaces of the inorganic porous support;

applying a membrane precursor composition; wherein, when the one or more porous inorganic intermediate layers have not been applied to the inorganic porous support's inner channel surfaces, the membrane precursor composition is applied to the inner channel surfaces of the inorganic porous support and wherein, when the one or more porous inorganic intermediate layers have been applied to the inorganic porous support's inner channel surfaces, the membrane precursor composition is applied to the surface of the one or more porous intermediate layers; and

curing the membrane precursor composition under conditions effective for the crosslinking agent to crosslink the poly(vinyl alcohol-co-vinylamine).

Suitable inorganic porous supports that can be used in the practice of the method of the present invention include those discussed hereinabove.

For example, in certain embodiments, the porous walls which define the inner channels' surfaces have a median pore size of 500 nanometers or less, such as in cases where the porous walls which define the inner channels' surfaces have a median pore size of from 5 nanometers to 500 nanometers, from 5 nanometers to 400 nanometers, from 5 nanometers to 300 nanometers, from 5 nanometers to 400 nanometers, from 5 nanometers to 300 nanometers, from 5 nanometers to 400 nanometers, from 5 nanometers to 200 nanometers, from 5 nanometers to 100 nanometers, from 5 nanometers to 50 nanometers, etc. Illustratively, in certain embodiments, the one or more porous inorganic intermediate layers have not been applied to the inorganic porous support's inner channel surfaces, the membrane precursor composition is applied to the inner channel surfaces of the inorganic porous support, and the porous walls which define the inner channels' surfaces have a median pore size of 500 nanometers or less, such as in cases where the porous walls which define the inner channels' surfaces have a median pore size of from 5 nanometers to 500 nanometers, from 5 nanometers to 400 nanometers, from 5 nanometers to 300 nanometers, from 5 nanometers to 400 nanometers, from 5 nanometers to 300 nanometers, from 5 nanometers to 400 nanometers, from 5 nanometers to 200 nanometers, from 5 nanometers to 100 nanometers, from 5 nanometers to 50 nanometers, etc.

The inorganic porous support can be provided in a variety of different ways. For example, it can be obtained commercially. Alternatively, it can be prepared by methods that are well known to those skilled in the art.

Illustratively, suitable inorganic porous supports can be prepared in accordance with the methods described in co-pending U.S. Patent Application No. 60/874,070, filed Dec. 11, 2006, which is hereby incorporated by reference; in U.S. Pat. No. 3,885,977 to Lachman et al., which is hereby incorporated by reference; and in U.S. Pat. No. 3,790,654 to Bagley et al., which is hereby incorporated by reference.

For example, the inorganic porous support can be made by combining 60 wt % to 70 wt % of alpha-alumina (having a particle size in the range of 5 microns to 30 microns), 30 wt % of an organic pore former (having a particle size in the range of 7 microns to 45 microns), 10 wt % of a sintering aid, and other batch components (e.g., crosslinker, etc.). The combined ingredients are mixed and allowed to soak for a period of time (e.g., 8 to 16 hours). The mixture is then shaped into a green body by extrusion. The resulting green body is sintered (e.g., at a temperature of 1500° C. or greater for a suitable period of time, such as for 8 to 16 hours) to form an inorganic porous support.

As noted above, the method of the present invention can optionally include applying one or more porous inorganic intermediate layers to the inner channel surfaces of the inorganic porous support. Situations in which one might wish to use the optional porous inorganic intermediate layer(s) and suitable materials from which the porous inorganic intermediate layer(s) can be made include those that are discussed hereinabove.

In those situations in which the method of the present invention includes applying one or more porous inorganic intermediate layers to the inner channel surfaces of the inorganic porous support, the one or more porous inorganic intermediate layers can be applied to the inner channel surfaces using any suitable method. Illustratively, the porous inorganic intermediate layers can be applied by coating (e.g., flow coating in a suitable liquid) ceramic or other inorganic particles of appropriate size (e.g., on the order of a few to a few tens of nanometers) onto the inner channel surfaces of the inorganic porous support. The inorganic porous support coated with the ceramic or other inorganic particles is then dried and fired to sinter the ceramic or other inorganic particles, thus forming a porous inorganic intermediate layer. Additional porous inorganic intermediate layers can be applied to the coated inorganic porous support by repeating the above process (e.g., with different inorganic particles), typically with drying and firing after each layer's application.

The drying and firing schedules can be adjusted based on the materials used in the inorganic porous support and in the porous inorganic intermediate layer(s). For example, an alpha-alumina intermediate layer applied to an alpha-alumina porous support can be dried in a humidity and oxygen controlled environment while maintaining a suitable temperature (e.g., 120° C.) for a suitable period of time (e.g., 5 hours); and, once dried, the alpha-alumina intermediate layer can be fired under conditions effective to remove organic components and to sinter the intermediate layer's alpha-alumina particles, such as, for example, at a temperature of from 900° C. to 1200° C. under a controlled gas environment.

Suitable methods for coating ceramic or other inorganic particles onto the inner channel surfaces of inorganic porous support and for forming them into porous inorganic intermediate layers are described, for example, in U.S. patent application Ser. No. 11/729,732, filed Mar. 29, 2007, which is hereby incorporated by reference; in U.S. patent application Ser. No. 11/880,066, filed Jul. 19, 2007, which is hereby incorporated by reference; and in U.S. patent application Ser. No. 11/880,073, filed Jul. 19, 2007, which is hereby incorporated by reference.

Irrespective of whether or not the method of the present invention includes the optional step of applying one or more porous inorganic intermediate layers to the inner channel surfaces of the inorganic porous support, the method also involves the application of a membrane precursor composition. In those cases where one or more porous inorganic intermediate layers have not been applied to the inorganic porous support's inner channel surfaces, the membrane precursor composition is applied to the inner channel surfaces of the inorganic porous support. In those cases where the one or more porous inorganic intermediate layers have been applied to the inorganic porous support's inner channel surfaces, the membrane precursor composition is applied to the surface of the one or more porous intermediate layers.

It will be appreciated that the membrane precursor composition need not be applied to all of the channels. For example, the membrane precursor composition can be applied to all of the inner channel surfaces of the inorganic porous support; or the membrane precursor composition can be applied to some of the inner channel surfaces of the inorganic porous support; and the phrase “the membrane precursor composition is applied to the inner channel surfaces of the inorganic porous support” is meant to encompass both situations. Likewise, in those cases where the porous intermediate layer(s) is employed, the membrane precursor composition can be applied to the surface of the one or more porous intermediate layers in every channel; or the membrane precursor composition can be applied to the surface of the one or more porous intermediate layers in some of the channels; and the phrase “the membrane precursor composition is applied to the surface of the one or more porous intermediate layers” is meant to encompass both situations. Illustratively, depending on the expected conditions of use and the configuration of the channels in the inorganic porous support, it may be desirable to plug certain channels in the inorganic porous support, and the membrane precursor composition need not be applied to these channels; or it may be desirable not to plug certain channels in the inorganic porous support and not have a polymer membrane in these channels; or both.

Application of the membrane precursor composition (i.e., to the inner channel surfaces of the inorganic porous support or to the surface of the one or more porous intermediate layers) can be carried out by any suitable process.

Illustratively, the membrane precursor composition can be applied onto the inner channel surfaces of the inorganic porous support or onto the surface of the one or more porous intermediate layers by a dip coating procedure, such as by a procedure that involves dip-coating under vacuum or pseudo-vacuum, for example, as described in Example 4 of the present application; or by a flow-coating procedure, for example, as described in Example 7 of the present application using a flow-coating apparatus described in U.S. patent application Ser. No. 11/729,732, filed Mar. 29, 2007, which is hereby incorporated by reference.

Suitable membrane precursor compositions that can be used in the practice of the method of the present invention include those discussed hereinabove. Suitable thicknesses and other suitable characteristics of the membrane precursor composition are also discussed hereinabove and shall not be repeated here.

The method also includes curing the membrane precursor composition under conditions effective for the crosslinking agent to crosslink the poly(vinyl alcohol-co-vinylamine). Suitable curing conditions include those described hereinabove. In certain embodiments, the polymer membrane that is produced by curing the membrane precursor composition is non-porous. In certain embodiments, the polymer membrane that is produced by curing the membrane precursor composition includes pores having a median pore size of 300 nm or less, such as in cases where the polymer membrane includes pores having a median pore size of 250 nm or less, of 200 nm or less, of 150 nm or less, of 100 nm or less, of 75 nm or less, of 50 nm or less, of 40 nm or less, of 30 nm or less, of 20 nm or less, of 10 nm or less, of 5 nm or less, of 4 nm or less, of 3 nm or less, of 2 nm or less, of 1 nm or less, of 0.5 nm or less, of 0.4 nm or less, of 0.3 nm or less, of 0.2 nm or less, of 0.1 nm or less.

In certain embodiments, the one or more porous inorganic intermediate layers have not been applied to the inorganic porous support's inner channel surfaces, the membrane precursor composition is applied to the inner channel surfaces of the inorganic porous support, and the polymer membrane that is produced by curing the membrane precursor composition is non-porous. In certain embodiments, the one or more porous inorganic intermediate layers have not been applied to the inorganic porous support's inner channel surfaces, the membrane precursor composition is applied to the inner channel surfaces of the inorganic porous support, and the polymer membrane that is produced by curing the membrane precursor composition includes pores having a median pore size of 300 nm or less, such as in cases where the polymer membrane includes pores having a median pore size of 250 nm or less, of 200 nm or less, of 150 nm or less, of 100 nm or less, of 75 nm or less, of 50 nm or less, of 40 nm or less, of 30 nm or less, of 20 nm or less, of 10 nm or less, of 5 nm or less, of 4 nm or less, of 3 nm or less, of 2 nm or less, of 1 nm or less, of 0.5 nm or less, of 0.4 nm or less, of 0.3 nm or less, of 0.2 nm or less, of 0.1 nm or less.

In certain embodiments, the membrane precursor composition further includes a second polyamine. In cases where the membrane precursor composition further includes a second polyamine, the membrane precursor composition is cured under conditions effective for the crosslinking agent to crosslink the poly(vinyl alcohol-co-vinylamine) and the second polyamine with one another.

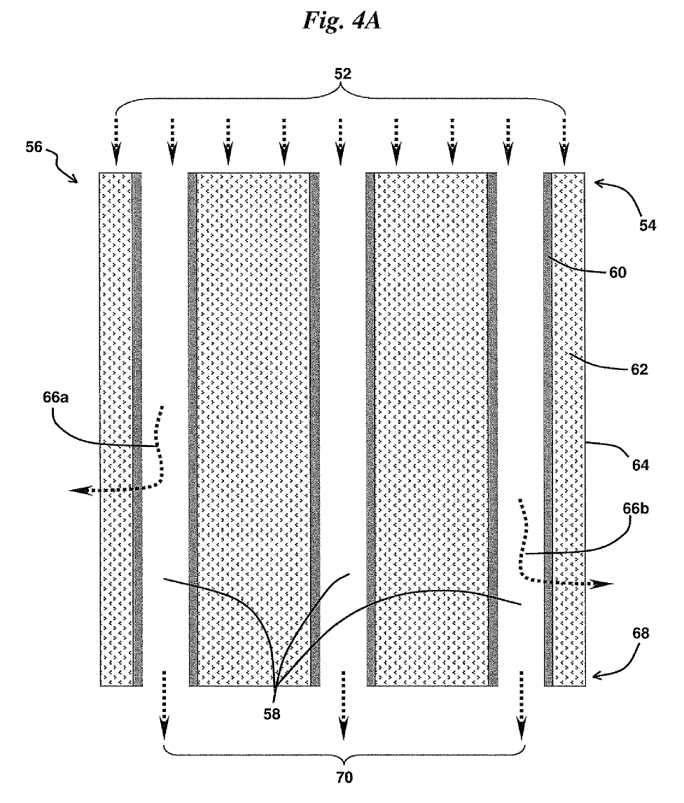

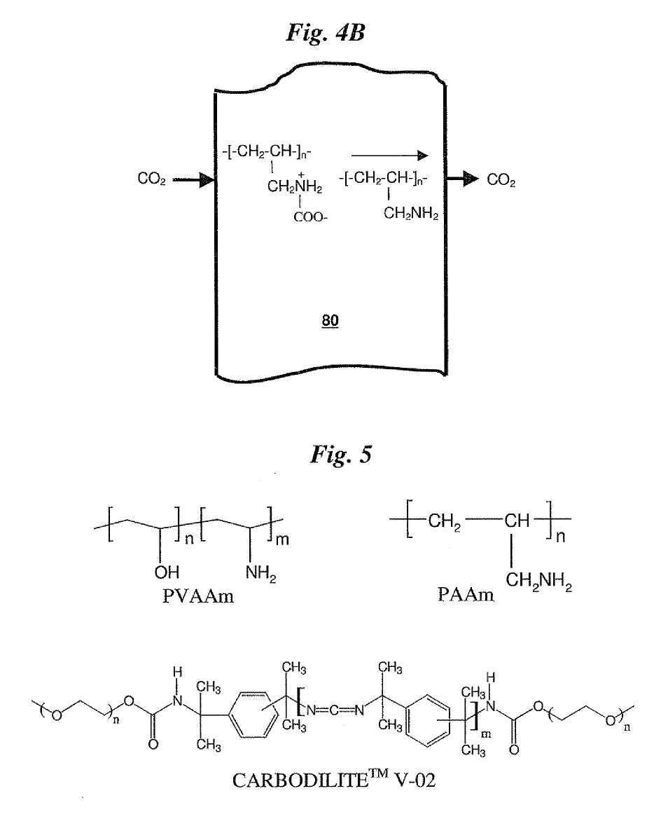

Hybrid membrane structures of the present invention and hybrid membrane structures made in accordance with the methods of the present invention can be used in a variety of applications, such as in methods for reducing carbon dioxide content in a gas stream. For example, carbon dioxide content in a gas stream can be reduced by a method that includes: introducing a feed gas comprising carbon dioxide into a first end of a hybrid membrane structure of the present invention; and collecting a retentate gas stream lower in carbon dioxide content than the feed gas from a second end of the hybrid membrane structure. The process is illustrated in FIG. 4A. Feed gas 52 is introduced into first end 54 of hybrid membrane structure 56 and passes into channels 58. Some of the carbon dioxide molecules in feed gas 52 permeates through polymer membrane 60 that is disposed on channels 58, into inorganic porous support 62, and, after passing through the pores of inorganic porous support 62, emanates from hybrid membrane structure 56's outer surface 64. The path of such carbon dioxide molecules is represented by arrows 66a and 66b. The remainder of feed gas 52 remains in channels 58 and is permitted to exit second end 68 of hybrid membrane structure 56 as retentate gas stream 70. Retentate gas stream 70 that is collected from second end 68 of hybrid membrane structure 56 is lower in carbon dioxide content than feed gas 52. Depending on the application and the nature of the feed gas involved, the collected gas can be stored, used as a feed gas in a further process, or discharged to the atmosphere. Carbon dioxide which emanates from hybrid membrane structure 56's outer surface 64 can be collected and stored, used in some other process, or discharged to the atmosphere. The feed gas can further include (i.e., in addition to the carbon dioxide) one or more other gases such as hydrogen, water vapor, carbon monoxide, nitrogen, hydrocarbons, and combinations thereof.

FIG. 4B is a scheme showing a possible mechanism for separating CO₂ from a feed gas using a polymer membrane (80) according to the present invention.

The present invention is further illustrated by the following non-limiting examples.

### EXAMPLES

### Example 1

### Materials

The following materials were used in the work described in these Examples: Polyallyamine (“PAAm”): in neat acid form, 15% aqueous solution, Mn ˜15000, Beckmann Chemical Corp, Inc. Poly(vinyl alcohol-co-vinylamine) (“PVAAm”): Mn 30000-50000, Erkol L12, containing 12% mol vinylamine, from Celanese Corporation. CARBODILITE™ V-02: an oligomer, from Nisshinbo Industries, Inc., Tokyo, Japan. Formaldehyde: from Aldrich. The chemical structures of PAAm, PVAAm, and CARBODILITE™ V-02 are set forth in FIG. 5.

### Example 2

### Preparation of Poly(vinyl alcohol-co-vinylamine) Aqueous Solution

A 1000-ml Mason jar was charged 549.0 g of deionized (“DI”) water, and then the Mason jar was placed in a hot (85° C.) glycol bath. A mechanical stirrer was then installed, and stirring was set to 300 rpm. The jar was then charged with 51.0 g PVAAm resin. Stirring speed was gradually increased to 600 rpm and maintained for 2 hours. After this, the Mason jar was removed from the hot bath, and the solution was filtered by passing it through a blue paper towel in order to remove the insoluble residue. The filtered solution was ready for use after cooling to room temperature.

### Example 3

### Preparation of Membrane Solution and Making a PVAAm/PAAm/CARBODILITE™ V-02 Membrane

A 20-ml vial was charged with 5.0 g of 8% PVAAm aqueous solution (prepared as in Example 2) and with 6.0 g of 15% PAAm solution, and this was mixed well with stirring. To the solution was then added 0.15 g of CARBODILITE™ V-02, and this was mixed well under stirring. After mixing, the solution was ready for making a membrane by casting the solution on a PVC film substrate. A bird type film applicator was used to cast the membrane. The cast membrane solution was dried overnight at room temperature and was then put into an oven and cured at 150° C. for 4 hours. The resulting film had a thickness of about 50 microns.

### Example 4

### Preparation of Membrane Solution and Making a PVAAm/PAAm/Formaldehyde Membrane

A 20-ml vial was charged with 5.0 g of 8% PVAAm aqueous solution (prepared as in Example 2) and with 0.36 g of formaldehyde (18.5% aqueous solution), and this was mixed well with stirring. To the solution was then added 5.0 g of 15% PAAm aqueous solution, and this was mixed well with stirring. A cloudy solution was observed at the very beginning, but the cloudiness disappeared after a few minutes of stirring. After this, the solution was ready for making a membrane. The membrane was made by casting the membrane solution on a glass substrate or a polyester film substrate. A bird type film applicator was used to cast the membrane. The cast film was dried at room temperature overnight and was then placed into an oven and cured at 100° C. for 4 hours. The resulting film had a thickness of about 50 microns.

### Example 5

### Coating Polymer Membranes onto Ceramic Monolith Channel-Walls

An alpha-alumina based ceramic monolith membrane support was used in the experiments described in this Example 5. It was produced by extrusion and had a mean pore size of about 3.5 microns, a porosity of 45%, an outer diameter of 9.7 mm, and a length of 131 mm. The alpha-alumina based ceramic monolith membrane support comprised 19 rounded channels (mean diameter about 0.75 mm) being uniformly distributed over the cross-section. An alpha-alumina modification coating layer with mean pore size about 100 nm was first deposited on the support at about 10 microns thickness, and a gamma-alumina layer was further deposited at about 1-2 microns thickness with a mean pore size about 5 nm.

The mass of a dried ceramic monolith was measured. The ceramic monolith was then wrapped with TEFLON™ tape, and the mass was measured again. On one end of the ceramic monolith, a pseudo vacuum system (a syringe) was connected. Then, the other end of the ceramic monolith was soaked in the membrane solution while withdrawing the syringe. After the solution came out from the end of the monolith which was connected to the syringe for 10 seconds, the solution was pushed out, and the ceramic monolith was spun end-over-end, for 45 seconds at about 500 rpm to remove the extra solution from the channels of the ceramic monolith. The coated ceramic monolith was air-dried for 2 hours and then put into a dryer. For the PVAAm/PAAm/formaldehyde membrane, the dryer was preheated to 100° C., and curing was carried out for 4 hours. For the PVAAm/PAAm/CARBODILITE™ V-02 membrane, the dryer was preheated to 150° C., and curing was carried out for 4 hours. After cooling to room temperature, the mass was measured, and the weight gain was calculated.

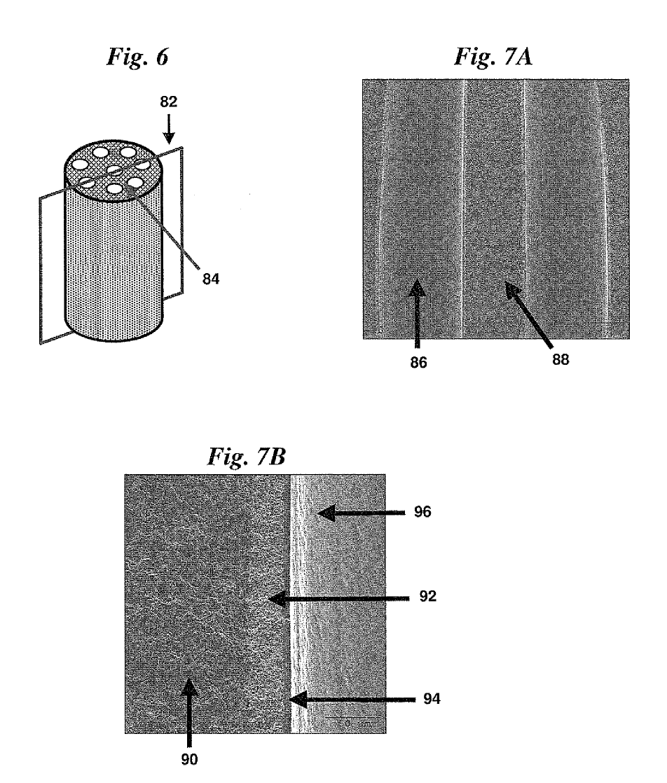

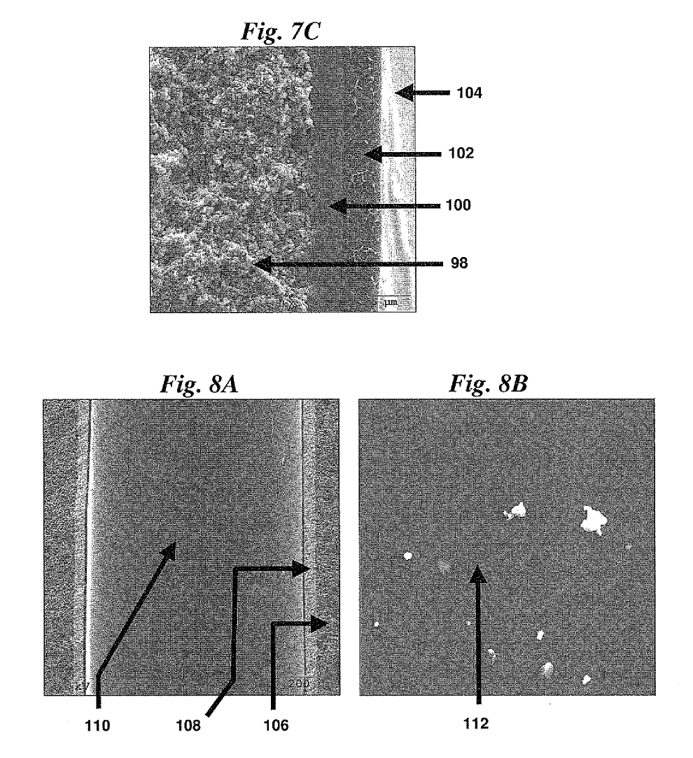

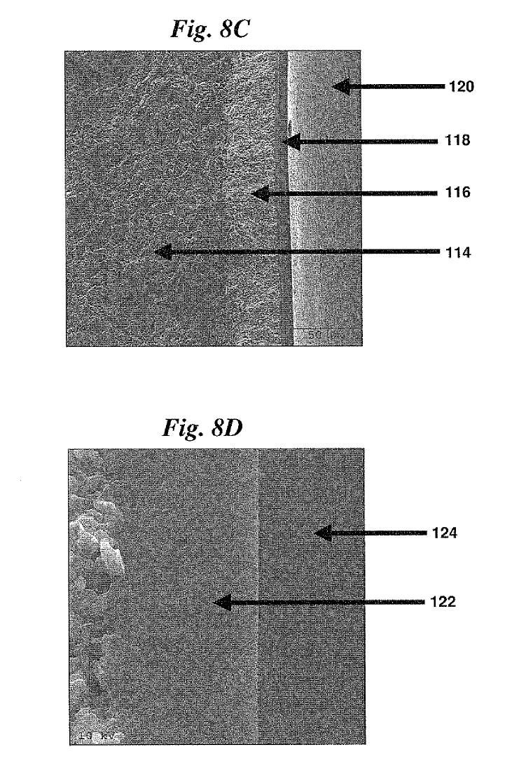

FIG. 6 is a schematic perspective view of a polymer membrane-coated ceramic monolith. The polymer membrane-coated ceramic monolith is similar in appearance to that produced in this Example 4, but shows fewer channels. The cutting plane (82) and imaging direction (arrow 84) are illustrated to provide a frame of reference for the SEM images set forth in FIGS. 7A-7C and 8A-8D.

FIGS. 7A-7C are SEM images of a cross-section of the ceramic monolith coated with the PVAAm/PAAm/CARBODILITE™ V-02 membrane at magnifications of 40×, 400×, and 5000×, respectively. In FIG. 7A, channel 86 and ceramic monolith substrate 88 are identified. In FIG. 7B, ceramic monolith substrate 90, alpha-alumina intermediate layer 92, gamma-alumina intermediate layer 94, and polymer membrane 96 are identified. In FIG. 7C, alpha-alumina intermediate layer 98, gamma-alumina intermediate layer 100, polymer membrane 102, and polymer membrane surface 104 are identified.

FIGS. 8A-8D are SEM images of a cross-section of the ceramic monolith coated with the PVAAm/PAAm/formaldehyde membrane at magnifications of 100×, 500×, and 10000×, and 20000× respectively. In FIG. 8A, ceramic monolith substrate 106 and alpha-alumina intermediate layer 108 are identified, and arrow 110 points to polymer membrane on channel surface. In FIG. 8C, ceramic monolith substrate 114, alpha-alumina intermediate layer 116, gamma-alumina intermediate layer 118, and polymer membrane 120 are identified. In FIG. 8D, gamma-alumina intermediate layer 122 and polymer membrane 124 are identified.

### Example 6

### Solubility Tests

Qualitative solubility tests were conducted for non-crosslinked PVAAm based films and for PVAAm membranes (crosslinked with CARBODILITE™ V-02). Additionally, solubility tests were conducted for non-crosslinked films made with PAAm (which, as indicated above, can be used as a co-component in the PVAAm based membrane) and for membranes made with PAAm (crosslinked with CARBODILITE™ V-02).

Membranes and films for the solubility tests were prepared as follows. A 20-ml vial was charged with 5.0 g of 8% PVAAm aqueous solution and 0.1 g CARBODILITE™ V-02, and this was mixed well with stirring. After this, the solution was ready for making the membrane. The solution was cast into a film on a glass substrate using a bird type film applicator. The cast film was dried overnight at 50° C. in air, and it was then put into an oven and cured at 150° C. for 5 minutes to produce the membrane. The resulting film had a thickness about 50 microns. The same procedure was used to produce the PAAm membrane, except that the 20-ml vial was charged with 3.0 g of 15% PAAm aqueous solution and 0.2 g of CARBODILITE™ V-02). The same procedure was used to prepare films of the pure PVAAm and PAAm solutions on glass substrates (i.e., solutions without CARBODILITE™ V-02).

Solubility tests were carried out by placing the film or membrane (with the glass substrate) vertically into a beaker. Water was then added to the beaker such that half of the film or membrane was submerged in the water and the remaining half of the film or membrane was in air. The solubility of the film or membrane at room temperature was observed and recorded. The results are presented in Table 1.

TABLE 1

| Polymeric Membrane or Film | Solubility in Water at Room |
|---|---|
| System | Temperature |
| PVAAm | soluble |
| non heated | |
| PVAAm | difficult to dissolve |
| heated at 150° C. for 5 minutes | |
| PAAm | soluble |
| non heated | |
| PAAm | soluble |
| heated at 150° C. for 5 minutes | |
| PAAm/CARBODILITE ™ V-02 | swelling/gel |
| cured at 150° C. for 5 minutes | |
| PVAAm/PAAm/CARBODILITE ™ V-02 | swelling/gel |
| cured at 150° C. for 5 minutes | |

Our studies have shown that CARBODILITE™ V-02 decomposes well at temperatures over 100° C., producing active sites which react with the PVAAm and PAAm to achieve crosslinking. The qualitative solubility test results set forth in Table 1 demonstrate the effectiveness of CARBODILITE™ V-02 as a crosslinker for PVAAm and PAAm.

### Example 7

### Coating Polymer Membranes onto Ceramic Monolith Channel-Walls Using a Flow Coating Apparatus

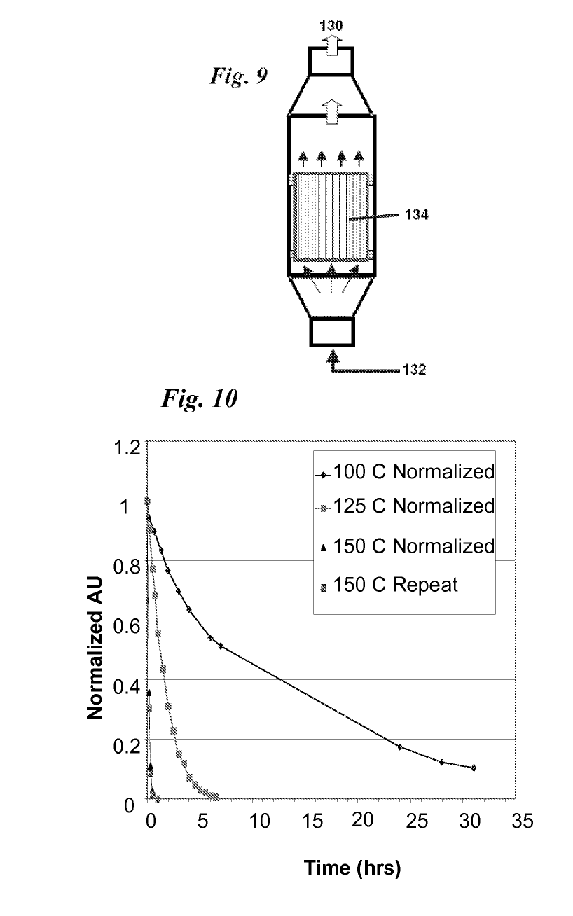

The mass of a dried ceramic monolith was measured. The ceramic monolith was then wrapped with TEFLON™ tape, and the mass was measured again. The TEFLON™-wrapped ceramic monolith was mounted in a flow coating apparatus shown schematically in FIG. 9 (details of which are described in U.S. patent application Ser. No. 11/729,732, filed Mar. 29, 2007, which is hereby incorporated by reference). Generally, referring to FIG. 9, vacuum 130 is applied at the top of the apparatus, and the vacuum draws polymer membrane solution 132 through ceramic monolith 134. Here, vacuum was applied until a pressure of about 150 mmHg was achieved. The PVAAm based membrane precursor solution was then put under the coating equipment, and the valve was turned so as to permit the PVAAm based membrane precursor solution to enter the coating equipment. Vacuum was maintained until the PVAAm based membrane precursor solution flowed from the top end of the ceramic substrate and for 10 seconds thereafter. After the 10-second period, the vacuum was released, and the PVAAm based membrane precursor solution was permitted to flow back into the reservoir. The coated ceramic monolith was then removed from the coating equipment, and the excess solution was removed by rotating the coated ceramic monolith in a spinning device at about 500 rpm for 45 seconds. The mass of the coated ceramic monolith was measured, and the TEFLON™ wrapping was then removed. The coated ceramic monolith was program-dried with a final temperature at 80° C. for 6 hours. The dried coated ceramic monolith was then cured at temperature of 150° C. for 15 minutes. The mass of the ceramic monolith (now coated with the polymer membrane) was measured, allowing the weight gain to be calculated.

### Example 8

### Discussion on the Use of Polycarbodiimides as Crosslinking Agents

As noted in Example 4, when formaldehyde was added to the PVAAm aqueous solution, the solution became cloudy, and the cloudiness disappeared after a few minutes under stirring. This suggests that the formaldehyde may be interacting with the PVAAm even while the PVAAm is in solution, and may be evidence of some solution-phase crosslinking. Although the solution-phase crosslinking does not appear to affect the ultimate formation of a membrane, use of formaldehyde may have a potential effect on the viscosity of the membrane precursor solution, which, in turn, can affect the coating process (e.g., by making in difficult to predictably and/or reproducibly cast the membrane precursor solution into a film having a desired thickness). The change in viscosity can be particularly problematic when the membrane precursor solution is to be cast into a film in tubular structures of narrow diameter, such as in the channels of ceramic monolith.

While not intending to be limited by any theory or mechanism by which CARBODILITE™ V-02 and other polycarbodiimide crosslinking agents may operate, it is believed that the potential viscosity problem can be avoided by using a polycarbodiimide crosslinking agent (e.g., CARBODILITE™ V-02). More particularly, it is believed that polycarbodiimide crosslinking agents, like CARBODILITE™ V-02, do not function at low temperature in solution but function well once the solvent is removed and temperatures are elevated. Thus, when CARBODILITE™ V-02 is used as the crosslinking agent, the viscosity of the membrane precursor solution remains unchanged until after the membrane precursor solution is cast into a film and dried and/or heated. This is consistent with the observation that, unlike formaldehyde, CARBODILITE™ V-02 did not produce any cloudiness when it was added to the PVAAm aqueous solution. FIG. 10 is a plot of normalized infrared peak intensity of the carbodiimide band (2119 cm⁻¹) as a function of time at varying temperatures and shows the kinetics for the reaction between PVAAm and CARBODILITE™ V-02. The plot indicates that the reaction rate increases considerably with increasing temperature.

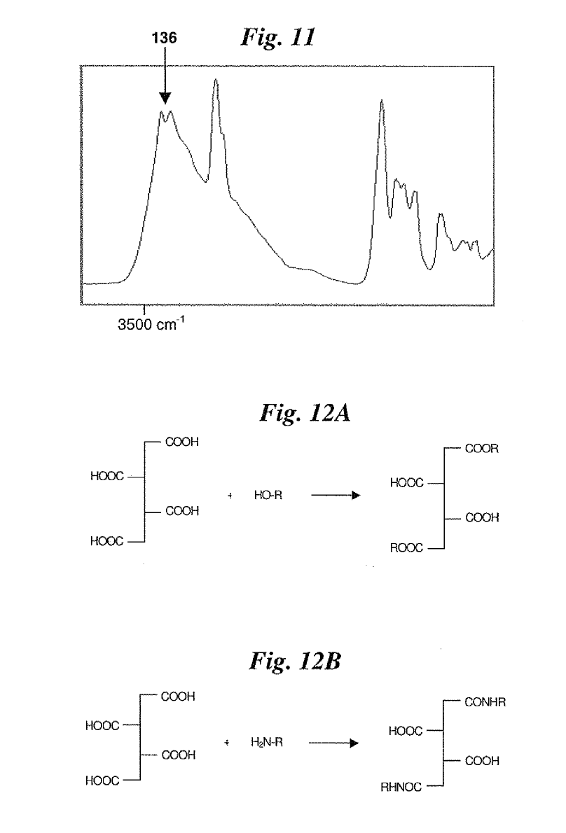

It was also observed that, when CARBODILITE™ V-02 was used as a crosslinking agent, the pH value of the membrane precursor solution (before casting and curing) is about 12-13. After casting and curing, the pH value of the swollen CARBODILITE™ V-02-crosslinked membrane (obtained after soaking the membrane in water) was about 11-12. Thus the pH of the material is only slightly changed by the crosslinking process (and, considering that the swollen membrane is not a real solution, its slightly lower pH is not unreasonable). While not intending to be limited by any theory or mechanism by which CARBODILITE™ V-02 and other polycarbodiimide crosslinking agents may operate, it is believed that the reaction of CARBODILITE™ V-02 and other and other polycarbodiimide crosslinking agents leads to the formation of guanidines, which are strongly alkaline, which, in turn, might account for the basic property of the membrane and its minimal pH change after crosslinking. The FTIR spectrum of a PAAm/PVAAm based membrane confirms the presence of amino groups in the membrane. This is shown in FIG. 11, where arrow 136 points to the bands that are attributed to amino groups.

### Example 9

### Use of Polyacids as Crosslinking Agents

The preparation of membrane solution and membrane is described below. A 20-ml vial was charged with 5.0 g of the 8% PVAAm aqueous solution (prepared as described in Example 2) and with 0.2 g of 15% BTCA (Aldrich) solution, and this was mixed well with stirring. Once the solution was mixed, it was ready for making a membrane. The membrane was prepared by casting the solution on a glass substrate using a bird type film. The cast membrane solution was dried at 50° C. in air for overnight and was then put into an oven and cured at 195° C. for 3-5 minutes. The resulting membrane had a thickness about 50 microns. The same procedure was used to prepare a film of pure PVAAm in the absence of BCTA and to prepare membranes and films of pure PAAm and of a mixture of PAAm and PVAAm, both in the presence or the absence of the BTCA.

The membranes and films were tested for solubility using the following procedure. The film or membrane (with the glass substrate) was placed vertically into a beaker. Water was then added to the beaker such that half of the film or membrane was submerged in the water and the remaining half of the film or membrane was in air. The solubility of the film or membrane at room temperature was observed and recorded. The results are presented in Table 2.

TABLE 2

| Polymeric Membrane or Film | Solubility in Water at Room |
|---|---|
| System | Temperature |
| PVAAm | soluble |
| non heated | |
| PVAAm | difficult to dissolve |
| heated at 195° C. for 5 minutes | |
| PAAm | soluble |
| non heated | |
| PAAm | soluble |
| heated at 195° C. for 5 minutes | |
| PVAAm/PAAm | soluble |
| non heated | |
| PVAAm/PAAm | swelling to dissolve |
| heated at 195° C. for 5 minutes | |
| PVAAm/BTCA | no swelling |
| cured at 195° C. for 5 minutes | |
| PAAm/BTCA | swelling/gel |
| cured at 195° C. for 5 minutes | |
| PVAAm/PAAm/BTCA | swelling/gel |
| cured at 195° C. for 5 minutes | |

The qualitative solubility test results set forth in Table 2 demonstrate the effectiveness of BTCA as a crosslinker for PVAAm and PAAm.

It should be noted that the aforementioned crosslinking reactions were carried out in the absence of a crosslinking catalyst. Use of a crosslinking catalyst, such as hydrated sodium hypophosphite (e.g., NaH₂PO₂.H₂O), can accelerate the reaction. Moreover, although the crosslinking reactions were carried out at 195° C., the crosslinking reaction can be carried out at other temperatures, such as at temperatures of from 150° C. to 210° C. or at a temperature that is just above the melting point of the polyacid.

While not intending to be limited by any theory or mechanism by which BTCA or other polyacid crosslinking agents may operate, it is believed that BTCA can react with the alcohol and amine functionalities as schematically illustrated in FIGS. 12A and 12B, respectively.

Moreover, again while not intending to be limited by any theory or mechanism by which polyacid crosslinking agents may operate, it is believed that use of a polyacid crosslinking agent can avoid the potential viscosity problems associated with the use of formaldehyde (as discussed in Example 8). More particularly, it is believed that, like polycarbodiimide crosslinking agents, polyacid crosslinking agents do not function at low temperature in solution but function well once the solvent is removed and temperatures are elevated. Thus, when a polyacid is used as the crosslinking agent, the viscosity of the membrane precursor solution remains unchanged until after the membrane precursor solution is cast into a film and dried and/or heated.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention, as defined in the claims which follow.

1. A polymer membrane comprising crosslinked poly(vinyl alcohol-co-vinylamine), wherein said membrane is non-porous or wherein said membrane is porous with pores having a median pore size of 300 nm or less.

2. A polymer membrane according to claim 1, wherein said polymer membrane is non-porous.

3. A polymer membrane according to claim 1, wherein said polymer membrane comprises pores having a median pore size of 300 nm or less.

4-8. (canceled)

9. A polymer membrane according to claim 1, wherein the polymer membrane further comprises a second polyamine and wherein the poly(vinyl alcohol-co-vinylamine) and the second polyamine are crosslinked with one another.

10. (canceled)

11. A polymer membrane according to claim 1, wherein the polymer membrane further comprises a polyallylamine and wherein the poly(vinyl alcohol-co-vinylamine) and the polyallylamine are crosslinked with one another.

12. A polymer membrane according to claim 1, wherein the polymer membrane further comprises a mobile non-polymeric amine.

13. (canceled)

14. A polymer membrane according to claim 1, wherein the poly(vinyl alcohol-co-vinylamine) is crosslinked with a polyacid crosslinking agent.

15. A polymer membrane according to claim 1, wherein the poly(vinyl alcohol-co-vinylamine) is crosslinked with 1,2,3,4-butanetetracarboxylic acid.

16. A polymer membrane according to claim 1, wherein the poly(vinyl alcohol-co-vinylamine) is crosslinked with a polycarbodiimide crosslinking agent.

17. A polymer membrane according to claim 1, wherein the poly(vinyl alcohol-co-vinylamine) is crosslinked with a polycarbodiimide crosslinking agent having the following formula:

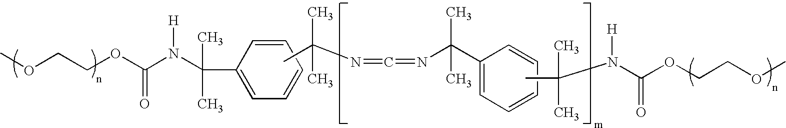

18. A polymer membrane comprising crosslinked poly(vinyl alcohol-co-vinylamine), wherein the polymer membrane further comprises a second polyamine and wherein the poly(vinyl alcohol-co-vinylamine) and the second polyamine are crosslinked with one another.

19. A method for preparing a polymer membrane according to claim 1, said method comprising:
providing a membrane precursor composition comprising a poly(vinyl alcohol-co-vinylamine) and a crosslinking agent;
casting the membrane precursor composition in the form of a film; and
curing the film under conditions effective for the crosslinking agent to crosslink the poly(vinyl alcohol-co-vinylamine).

20-39. (canceled)

40. A method for preparing a polymer membrane according to claim 18, said method comprising:
providing a membrane precursor composition comprising a poly(vinyl alcohol-co-vinylamine) and a crosslinking agent;
casting the membrane precursor composition in the form of a film; and
curing the film under conditions effective for the crosslinking agent to crosslink the poly(vinyl alcohol-co-vinylamine), wherein the membrane precursor composition further comprises a second polyamine and wherein the film is cured under conditions effective for the crosslinking agent to crosslink the poly(vinyl alcohol-co-vinylamine) and the second polyamine with one another.

41. A hybrid membrane structure comprising:
an inorganic porous support comprising a first end, a second end, and a plurality of inner channels having surfaces defined by porous walls and extending through the support from the first end to the second end;
optionally, one or more porous inorganic intermediate layers coating the inner channel surfaces of the inorganic porous support; and
a polymer membrane comprising crosslinked poly(vinyl alcohol-co-vinylamine); wherein, when the hybrid membrane structure does not comprise the one or more porous inorganic intermediate layers, the inner channel surfaces of the inorganic porous support comprise a median pore size of 500 nanometers or less and the polymer membrane coats the inner channel surfaces of the inorganic porous support; and wherein, when the hybrid membrane structure comprises the one or more porous inorganic intermediate layers, the polymer membrane coats the surface of the one or more porous intermediate layers.

42-54. (canceled)

55. A hybrid membrane structure comprising:
an inorganic porous support comprising a first end, a second end, and a plurality of inner channels having surfaces defined by porous walls and extending through the support from the first end to the second end;
optionally, one or more porous inorganic intermediate layers coating the inner channel surfaces of the inorganic porous support; and
a polymer membrane according to claim 1; wherein, when the hybrid membrane structure does not comprise the one or more porous inorganic intermediate layers, the polymer membrane coats the inner channel surfaces of the inorganic porous support and wherein, when the hybrid membrane structure comprises the one or more porous inorganic intermediate layers, the polymer membrane coats the surface of the one or more porous intermediate layers.

56. A hybrid membrane structure comprising:
an inorganic porous support comprising a first end, a second end, and a plurality of inner channels having surfaces defined by porous walls and extending through the support from the first end to the second end;
optionally, one or more porous inorganic intermediate layers coating the inner channel surfaces of the inorganic porous support; and
a polymer membrane according to claim 18; wherein, when the hybrid membrane structure does not comprise the one or more porous inorganic intermediate layers, the polymer membrane coats the inner channel surfaces of the inorganic porous support and wherein, when the hybrid membrane structure comprises the one or more porous inorganic intermediate layers, the polymer membrane coats the surface of the one or more porous intermediate layers.

57. A membrane precursor composition comprising:
a poly(vinyl alcohol-co-vinylamine);
a second polyamine; and
a crosslinking agent.

58-66. (canceled)

67. A method for making a hybrid membrane structure, said method comprising:
providing an inorganic porous support comprising a first end, a second end, and a plurality of inner channels having surfaces defined by porous walls and extending through the support from the first end to the second end;
optionally applying one or more porous inorganic intermediate layers to the inner channel surfaces of the inorganic porous support;
applying a membrane precursor composition comprising a poly(vinyl alcohol-co-vinylamine) and a crosslinking agent; wherein, when the one or more porous inorganic intermediate layers have not been applied to the inorganic porous support's inner channel surfaces, the inner channel surfaces of the inorganic porous support comprise a median pore size of 500 nanometers or less and the membrane precursor composition is applied to the inner channel surfaces of the inorganic porous support; and wherein, when the one or more porous inorganic intermediate layers have been applied to the inorganic porous support's inner channel surfaces, the membrane precursor composition is applied to the surface of the one or more porous intermediate layers; and
curing the membrane precursor composition under conditions effective for the crosslinking agent to crosslink the poly(vinyl alcohol-co-vinylamine).

68-74. (canceled)

75. A method for making a hybrid membrane structure, said method comprising:
providing an inorganic porous support comprising a first end, a second end, and a plurality of inner channels having surfaces defined by porous walls and extending through the support from the first end to the second end;
optionally applying one or more porous inorganic intermediate layers to the inner channel surfaces of the inorganic porous support;
applying a membrane precursor composition according to claim 57; wherein, when the one or more porous inorganic intermediate layers have not been applied to the inorganic porous support's inner channel surfaces, the membrane precursor coin position is applied to the inner channel surfaces of the inorganic porous support; and wherein, when the one or more porous inorganic intermediate layers have been applied to the inorganic porous support's inner channel surfaces, the membrane precursor composition is applied to the surface of the one or more porous intermediate layers; and
curing the membrane precursor composition under conditions effective for the crosslinking agent to crosslink the poly(vinyl alcohol-co-vinylamine) and the second polyamine with one another

76. A method for making a hybrid membrane structure, said method comprising:
providing an inorganic porous support comprising a first end, a second end, and a plurality of inner channels having surfaces defined by porous walls and extending through the support from the first end to the second end;
optionally applying one or more porous inorganic intermediate layers to the inner channel surfaces of the inorganic porous support;
applying a membrane precursor composition comprising a poly(vinyl alcohol-co-vinylamine) and a crosslinking agent; wherein, when the one or more porous inorganic intermediate layers have not been applied to the inorganic porous support's inner channel surfaces, the membrane precursor composition is applied to the inner channel surfaces of the inorganic porous support; and wherein, when the one or more porous inorganic intermediate layers have been applied to the inorganic porous support's inner channel surfaces, the membrane precursor composition is applied to the surface of the one or more porous intermediate layers; and
curing the membrane precursor composition under conditions effective for the crosslinking agent to crosslink the poly(vinyl alcohol-co-vinylamine) into a membrane which is non-porous or which is porous with pores having a median pore size of 300 nm or less.
